(19) United States
(12) Patent Application Publication
(10) Pub. No.: US 2025/0321664 A1
(43) Pub. Date: Oct. 16, 2025

(54) SYSTEMS AND METHODS FOR FACILITATING MEDIA PLAYBACK SYSTEM CONTROL

(71) Applicant: Sonos, Inc., Goleta, CA (US)

(72) Inventors: Brandon WRIGHT, Santa Barbara, CA (US); Sein WOO, Whittier, CA (US); Ryan Edward KITSON, Tillamook, OR (US)

(21) Appl. No.: 19/173,114

(22) Filed: Apr. 8, 2025

Related U.S. Application Data
(60) Provisional application No. 63/632,351, filed on Apr. 10, 2024.
(60) Provisional application No. 63/632,363, filed on Apr. 10, 2024.

(51) Int. Cl. G06F 3/0482; G06F 3/04847; G06F 3/16; G06F 16/638

(52) U.S. Cl. CPC G06F 3/0482; G06F 3/04847; G06F 3/165; G06F 16/638

(57) ABSTRACT

A device can be configurable to present a media dashboard interface that includes one or more of: (i) a recently played region, the recently played region comprising one or more selectable elements corresponding to one or more individual media items recently played by one or more playback devices of a media playback system associated with the device; (ii) a services region, the services region comprising one or more selectable elements corresponding to one or more individual media streaming services associated with a user profile; (iii) a favorites region, the favorites region comprising one or more selectable elements corresponding to one or more flagged media items associated with the user profile; or (iv) a sources region, the sources region comprising one or more selectable elements corresponding to one or more individual audio signal sources connected to one or more components of the media playback system.

### CROSS-REFERENCE TO RELATED APPLICATIONS

This application claims the benefit and priority to (1) U.S. Provisional Patent Application No. 63/632,351 entitled “SYSTEMS AND METHODS FOR FACILITATING MEDIA PLAYBACK SYSTEM CONTROL,” and filed on 10 Apr. 2024 and (2) U.S. Provisional Patent Application No. 63/632,363 entitled “USER INTERFACE FOR PLAYBACK DEVICE,” and filed on 10 Apr. 2024, the contents of each of which are incorporated by reference herein in their entireties.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 3A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D

FIG. 3F is a schematic diagram of an example voice input.

FIGS. 4A through 4D are schematic diagrams of a control device in various stages of operation in accordance with aspects of the disclosed technology.

FIG. 5 is front view of a control device.

FIG. 6 is a message flow diagram of a media playback system.

FIGS. 7A and 7B are an example operational flow diagram of a user device in accordance with the disclosed subject matter.

FIGS. 8A through 25 are example graphical user interface displays in accordance with the disclosed subject matter.

FIGS. 26A through 26D are an example operational flow diagram of a user device in accordance with the disclosed subject matter.

FIGS. 27A through 86 are example graphical user interface displays in accordance with the disclosed subject matter.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to systems and methods for facilitating media playback system control. Existing media playback system control frameworks often provide control functionality via graphical user interfaces presented at a user device (e.g., a smartphone, tablet, laptop, desktop computer, wearable device, etc.). Conventional graphical user interfaces for controlling a media playback system often include a menu or menu tray that includes selectable elements associated with various content or controls in various organizational domains, such as favorite/personalized media (e.g., for accessing media content flagged or saved as favorites in conjunction with a user or user profile), media browsing functionality (e.g., for accessing a media content or service library associated with a user or user profile), media search or explore functionality, playback and/or playback device control functionality (e.g., for selecting an input media signal or content, for controlling current or future media playback at one or more playback devices, for configuring settings or groupings/zones of playback devices), and/or others. After selection of a selectable element, the user device may navigate to and/or present content associated with the selected element. For example, after selection of a “favorite media” selectable element from a menu tray, the user device may display a graphical user interface that includes various media tracks that are flagged as favorites for an applicable user or user profile.

Conventional media playback system control frameworks can be cumbersome for users. For instance, to view media content in different organizational domains (e.g., favorite media tracks, browsable media tracks, novel media tracks), users typically navigate to different graphical user interface pages associated with the different organizational domains. For instance, to view favorite media tracks and browse media streaming service content, a user would typically first access the favorite media tracks by user input directed to an applicable selectable element in a menu tray and, afterward, subsequently access the media streaming service content by user input directed to another selectable element in the menu tray (or vice-versa). It can thus be challenging for users to rapidly, conveniently, or simultaneously access media content, services, or controls/settings associated with different organizational domains using conventional media playback system control frameworks.

In some embodiments disclosed herein, for example, a device is configurable to present a media dashboard interface (or “home screen” or “home interface” or simply “home”) that includes various regions. For instance, the media dashboard interface can include a recently played region, a services region, a favorites region, a sources region, and/or others.

The various regions of the media dashboard interface can include one or more selectable elements that are associated with various content/functionality. For instance, the selectable element(s) of the recently played region can correspond to one or more individual media items recently played on one or more playback devices of a media playback system associated with the device. As another example, the selectable element(s) of the services can correspond to one or more individual media streaming services associated with a user profile. As yet another example, the selectable element(s) of the favorites region can correspond to flagged media items associated with the user profile (e.g., media items flagged as favorites of the user of the user profile). As still another example, the selectable element(s) of the sources region can correspond to individual audio signal sources connected to one or more components of the media playback system.

The selectable elements of the various regions of the media dashboard can be presented on the media dashboard interface in navigable form. For instance, the selectable element(s) of a region of the media dashboard interface can be presented such that fewer than all of the available selectable elements of the region are shown on the screen/display of the device at a given time. User input directed to the region of the media dashboard interface can cause changing of the selectable element(s) displayed in the region of the media dashboard interface. As a non-limiting example, the user input can comprise touch and drag input directed to the region, which can cause the selectable element(s) of the region to move to reveal one or more previously off-screen or off-display selectable elements. Other user input methods or modalities are within the scope of the present disclosure (e.g., navigation arrow button presses, swipe gestures, voice commands, gaze input, tilt scrolling or motion sensors, external controllers, etc.).

The media dashboard interface itself can be presented as a single navigable page on the device, enabling navigation or scrolling among the regions thereof via user input (e.g., touch and drag input, or other input). In this regard, at least some regions of the media dashboard interface can be off-screen or on-screen at any given moment, and the regions that are off-screen or on-screen can be selectively and smoothly changed via user input (e.g., without using a jarring page change).

By providing a media dashboard interface that includes various regions with respective selectable elements that are navigable within the dashboard interface, users can rapidly, conveniently, or simultaneously access media content, services, or controls/settings associated with different organizational domains.

Furthermore, conventional media playback system control frameworks often include a “now playing” element or bar that can be overlaid or otherwise presented during navigation among various graphical user interfaces pages/screens. A now playing bar can include information for media content currently being played (e.g., title, artist/creator, album), playback controls (e.g., play/pause button, next/previous button, progress bar), volume control, and/or other features. While a now playing bar that includes multiple features can improve user control of and/or interaction with media currently being played, the inclusion of numerous features can cause a now playing bar to occupy a substantial amount of screen space, which can degrade user interaction with other on-screen content (e.g., especially for small devices such as smartphones).

In some embodiments disclosed herein, for example, a device is configurable to present a now playing bar simultaneously with other content (e.g., a media dashboard interface, or other interface). The now playing bar can include a media information region, a play/pause element, and a progress tracking element. The progress tracking element can provide a visual representation of playback progress of a media item currently being played by one or more playback devices of a media playback system associated with the device. The visual representation can comprise visual changing of a perimeter or area of the play/pause element. For instance, visual changing of the perimeter or area of the play/pause element can indicate the playback progress of the media item currently being played.

A now playing bar as described herein can include additional or alternative elements to those described above, such as a volume control element, a grouping control element, etc. A now playing bar as described herein can enable a desirable level of user control and/or interaction with the media content currently being played, while mitigating the spatial footprint of the now playing bar (e.g., so as not to detract from other on-screen content, such as a media dashboard interface or other interface(s)).

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

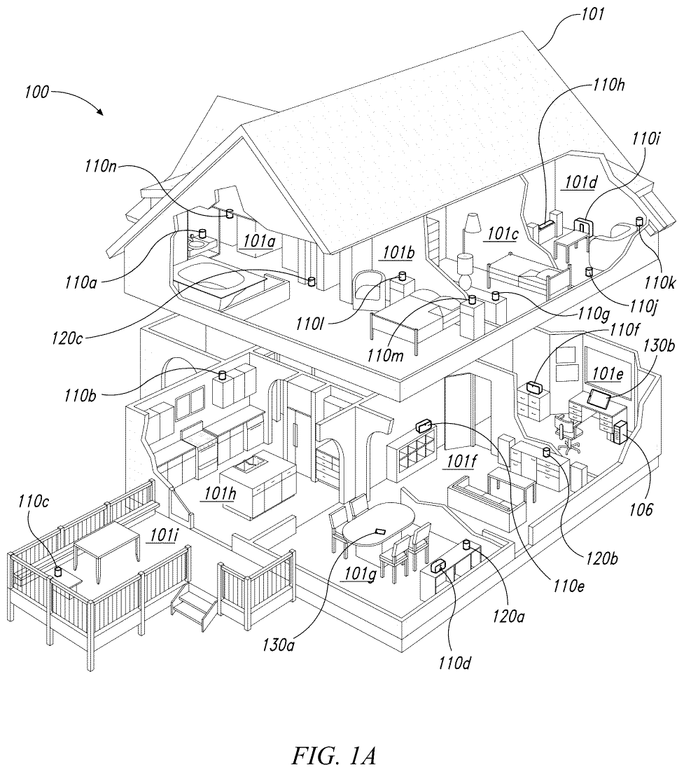

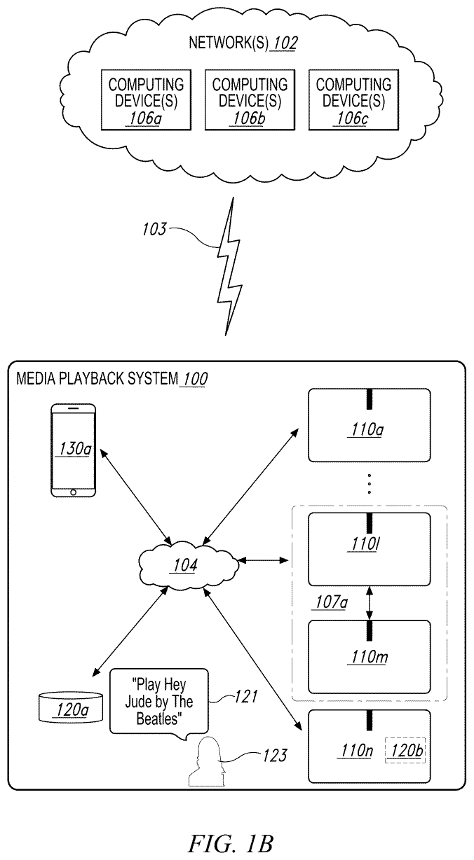

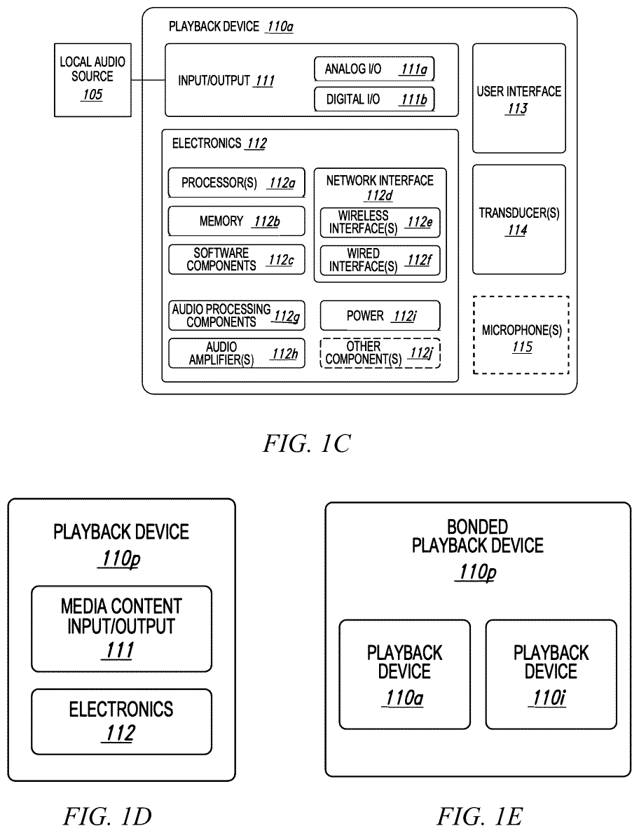

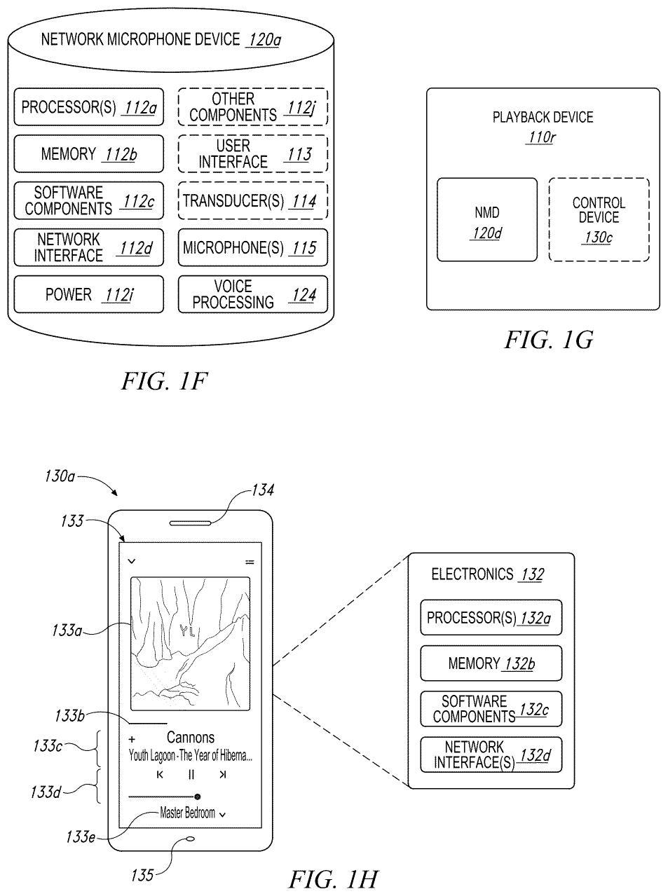

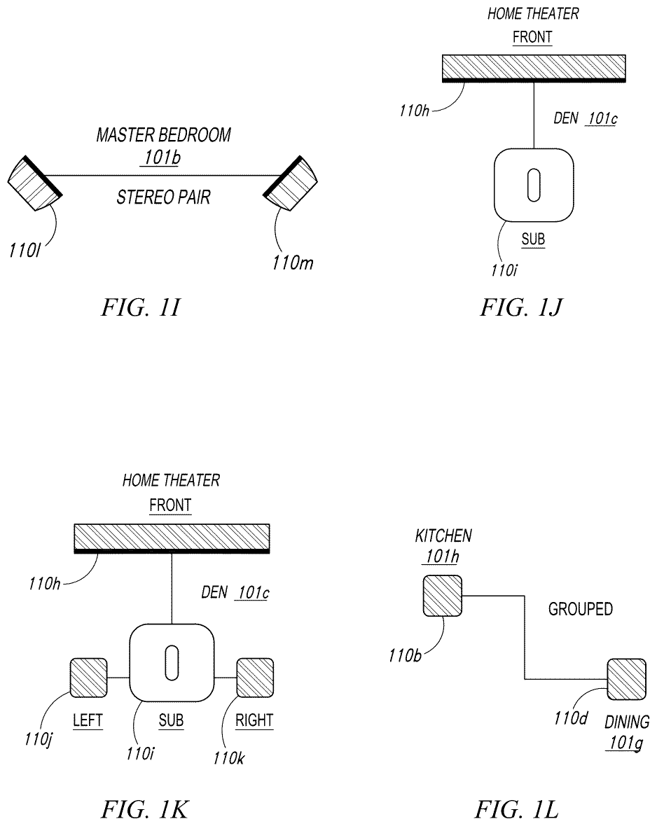

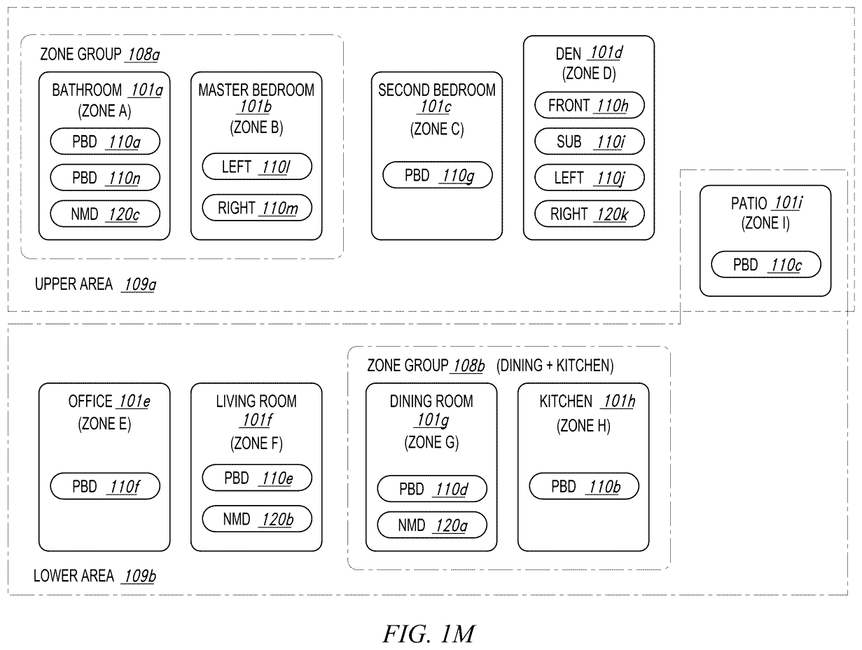

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a main bathroom 101a, a main bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, main bathroom 101a, main bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the main bathroom 101a, the second bedroom 101c, the office 101e, the living room 101f, the dining room 101g, the kitchen 101h, and the outdoor patio 101i each include one playback device 110, and the main bedroom 101b and the den 101d include a plurality of playback devices 110. In the main bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip-hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

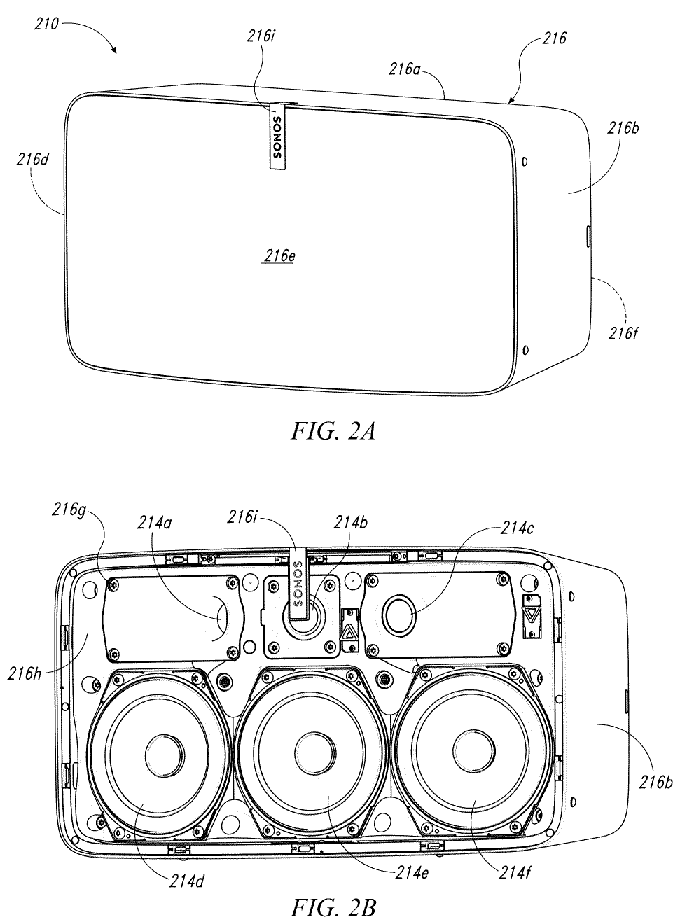

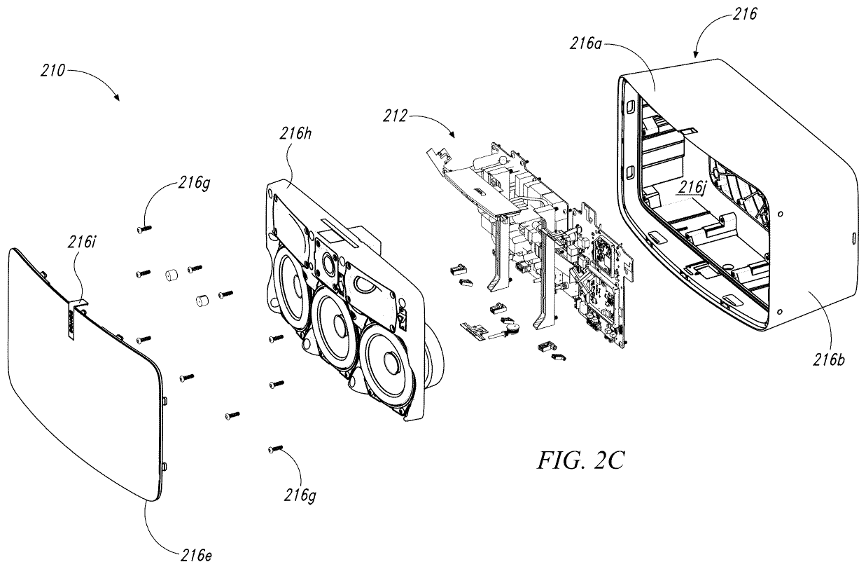

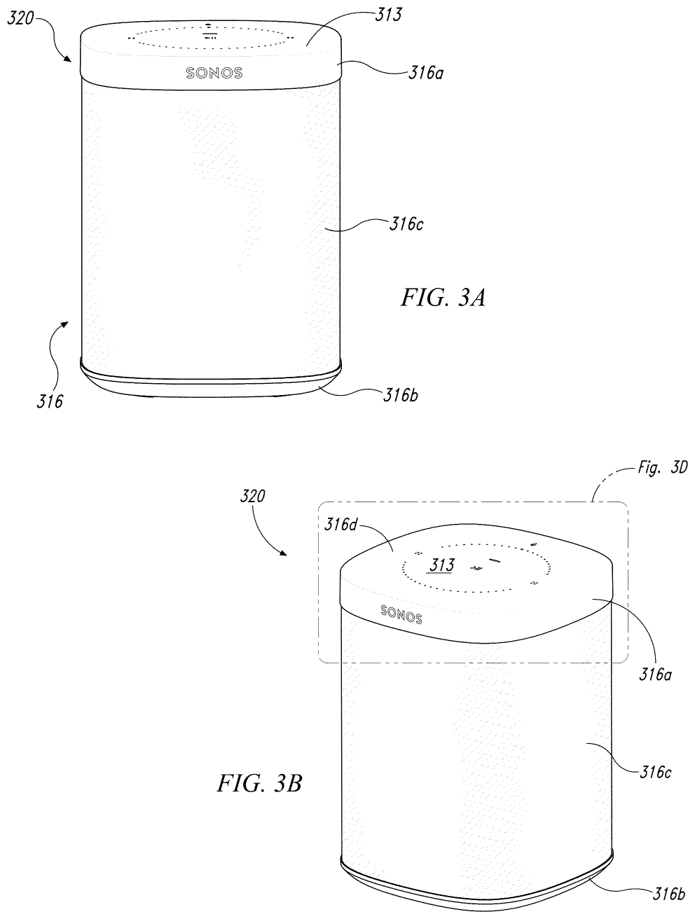

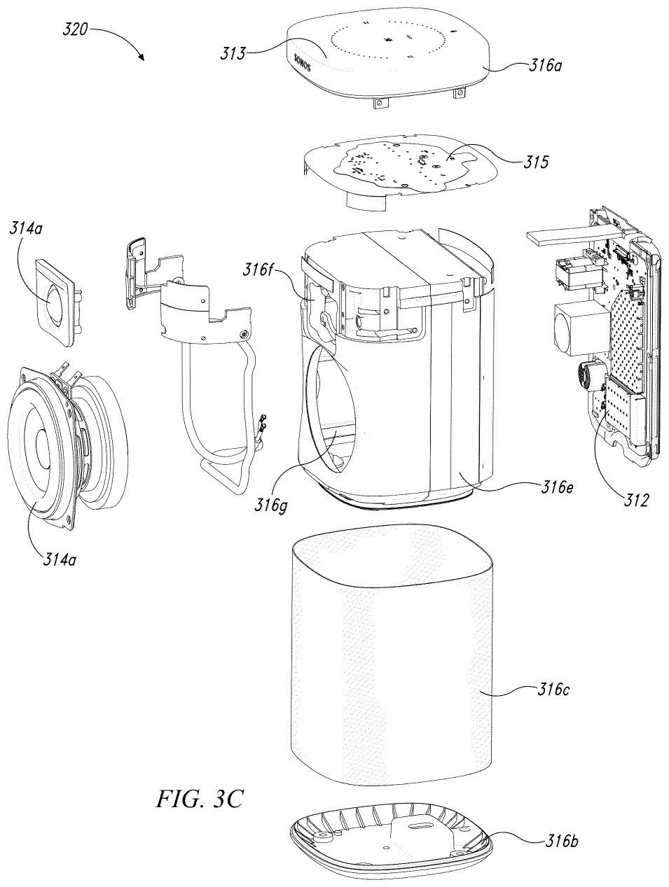

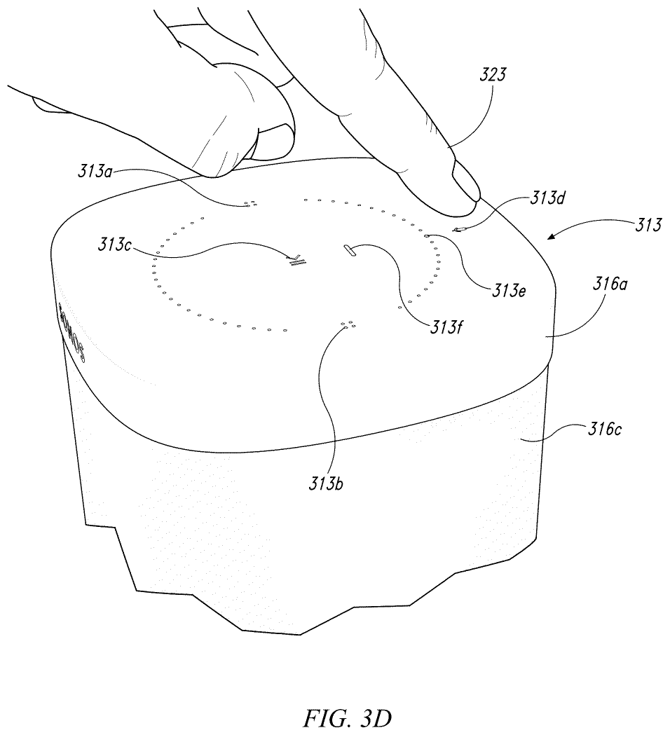

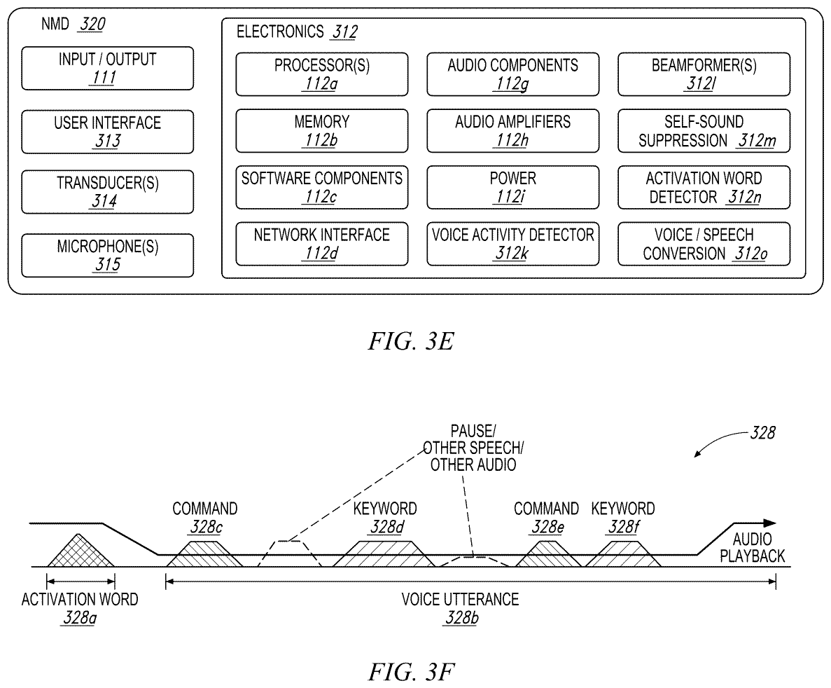

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

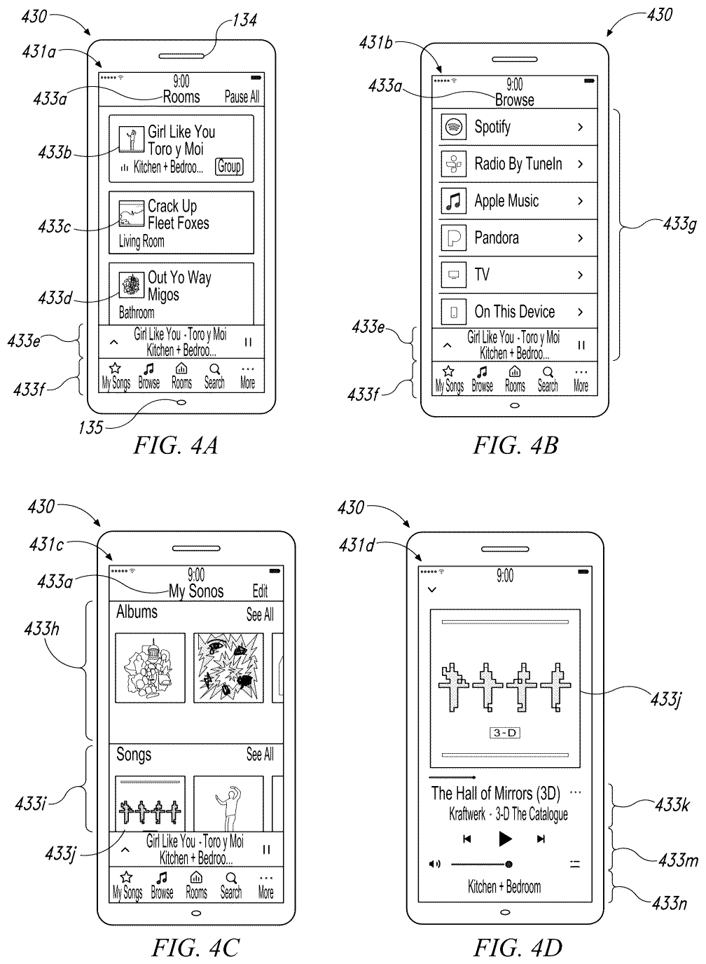

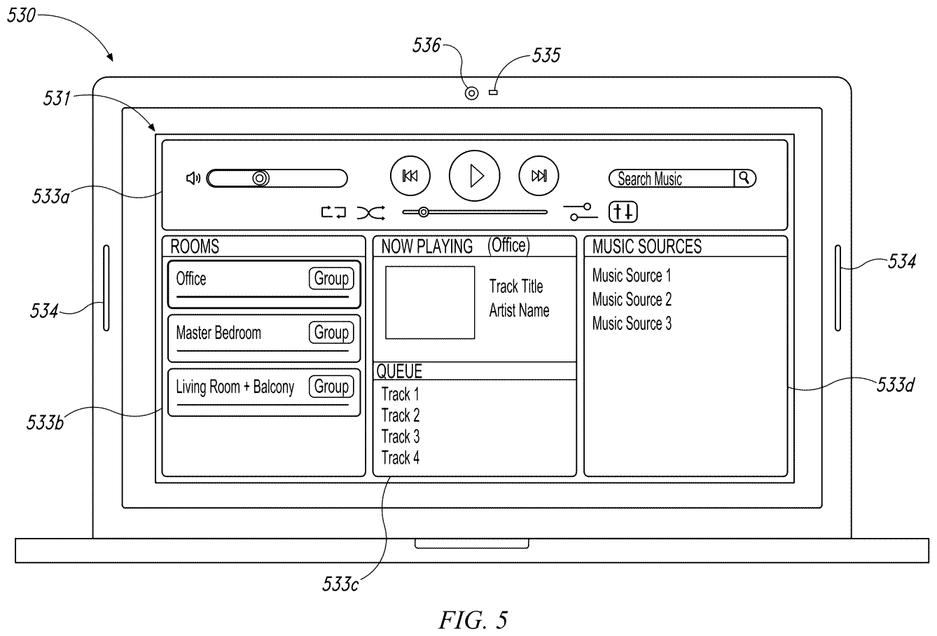

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Main Bathroom. Zone B may be provided as a single entity named Main Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities and may each render the full range of audio content the respective playback device is capable of. Nevertheless, merged devices may be represented as a single UI entity (i.e., a zone, as discussed above). For instance, the playback devices 110a and 110n the main bathroom has the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have been assigned a name such as “Dining+Kitchen”, as shown in FIG. 1M. In some embodiments, a zone group may be given a unique name selected by a user.

Certain data may be stored in a memory of a playback device (e.g., the memory 112c of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112 and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or be associated with a new playback queue that is empty or contains audio items from the playback queue associated with the established zone group before the established zone group was ungrouped. Similarly, the resulting second playback zone may be re-associated with the previous second playback queue or be associated with a new playback queue that is empty or contains audio items from the playback queue associated with the established zone group before the established zone group was ungrouped.

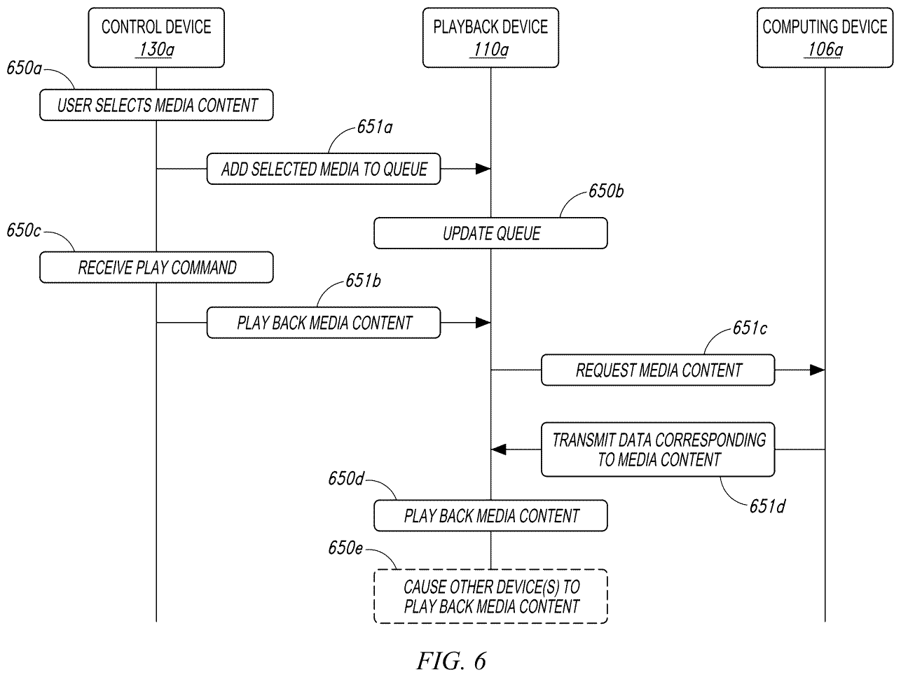

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a and begin playback of the selected media content in response to a message from the playback device 110a such that all of the devices in the group play back the selected media content in synchrony.

### IV. User Interface Flow

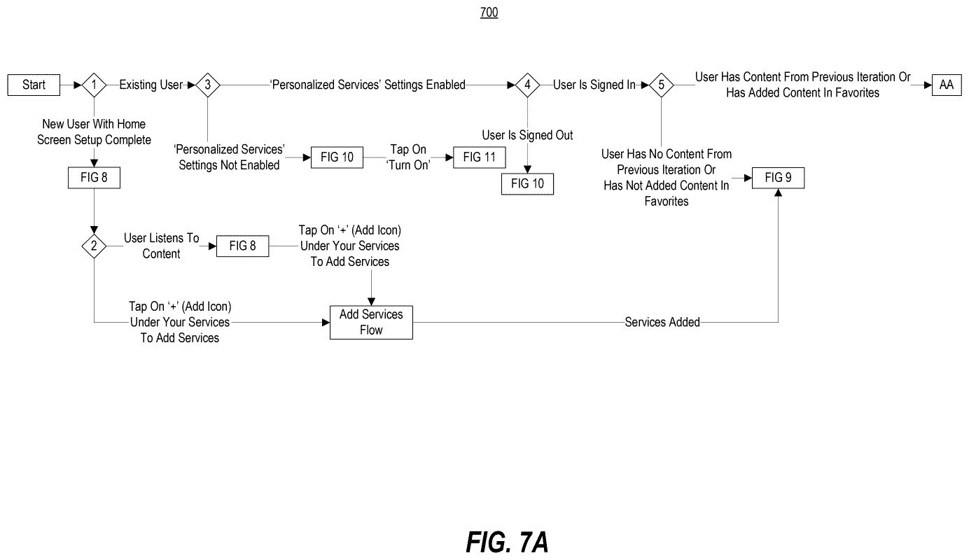

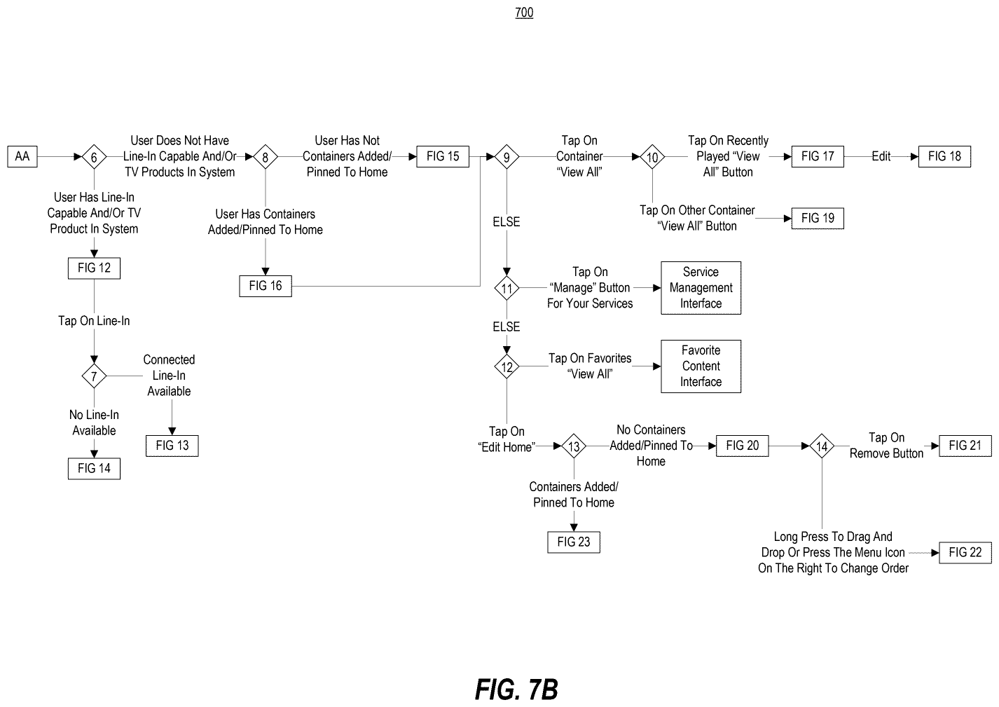

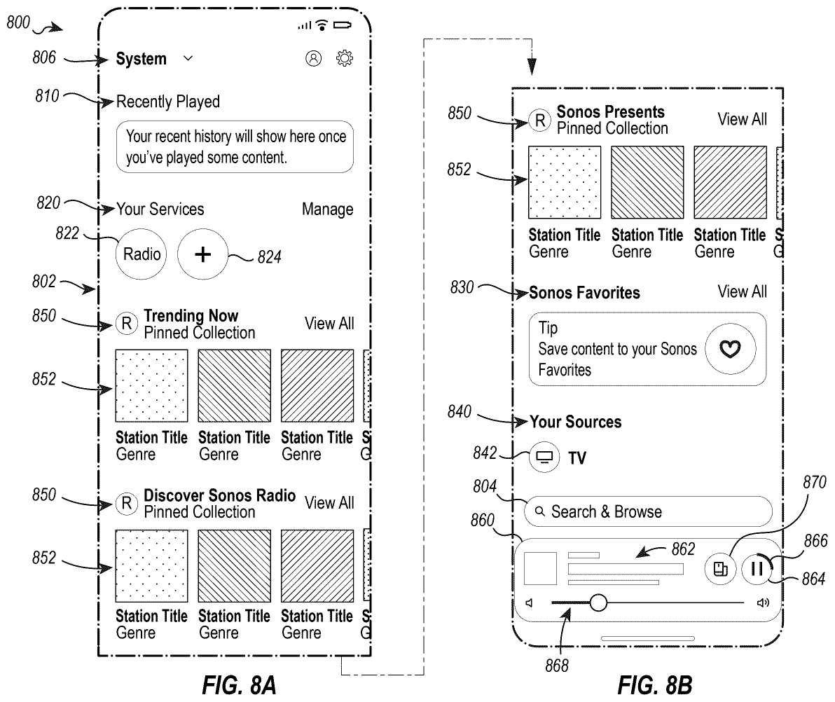

FIGS. 7A and 7B show an example operational flow diagram 700 of a user device, which may correspond to the one or more control devices 130 described hereinabove. One or more aspects of the operational flow diagram 700 may be implemented to configure or present a media dashboard interface (or “home screen” or “home interface” or simply “home”). The operational flow diagram 700 refers to FIGS. 8 through 25, which provide example graphical user interfaces that may be presented on the user device in association with acts or processes of the operational flow diagram 700.

FIG. 7A illustrates a “Start” block at which operations of the operational flow diagram 700 may begin. The Start block of the operational flow diagram 700 may correspond to running of an application and/or executable software (e.g., a “media application”) stored on the user device for configuring or controlling one or more components of a media playback system (e.g., media playback system 100) with which the user device is associated (e.g., for controlling one or more playback devices 110 of the media playback system 100).

Operational flow diagram 700 includes nodes at which the user device may take various actions or cause various results depending on states present, actions taken, and/or other factors. The nodes are represented in FIGS. 7A and 7B as diamond or circular shapes, which may include numerical labels (e.g., “node 1”, “node 2”, etc.) for ease of navigation. Operational flow among the blocks and nodes in operational flow diagram 700 is indicated by arrows, which may be labeled to indicate states present, actions taken, results, and/or other factors associated with the operational flow.

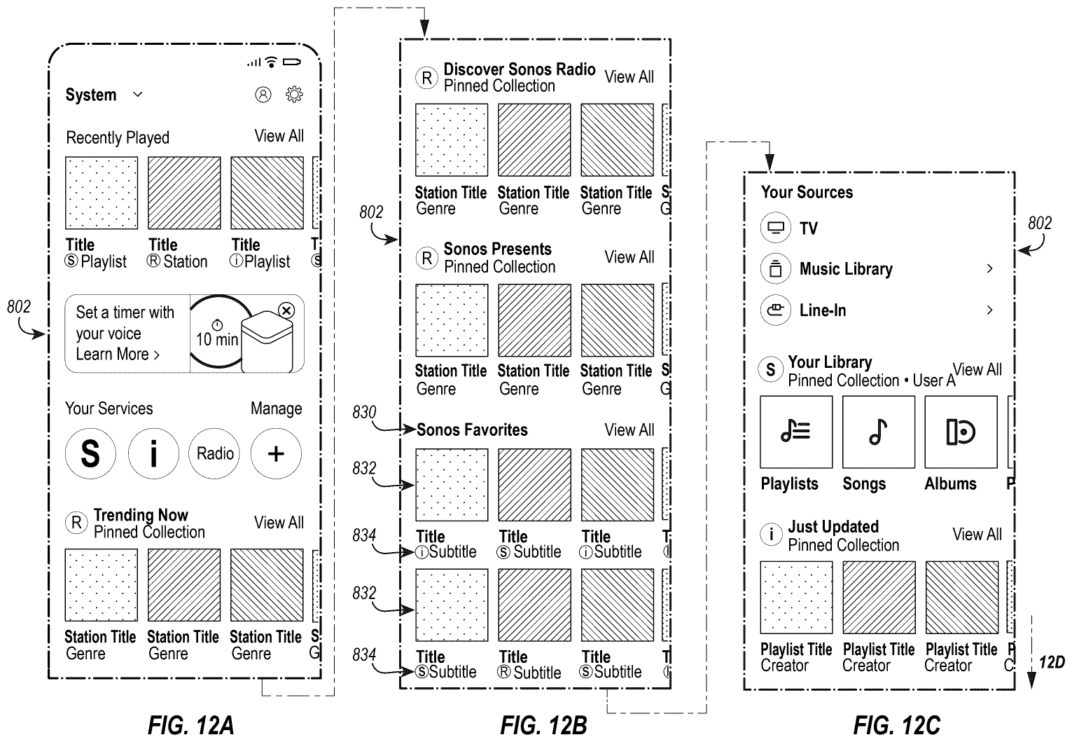

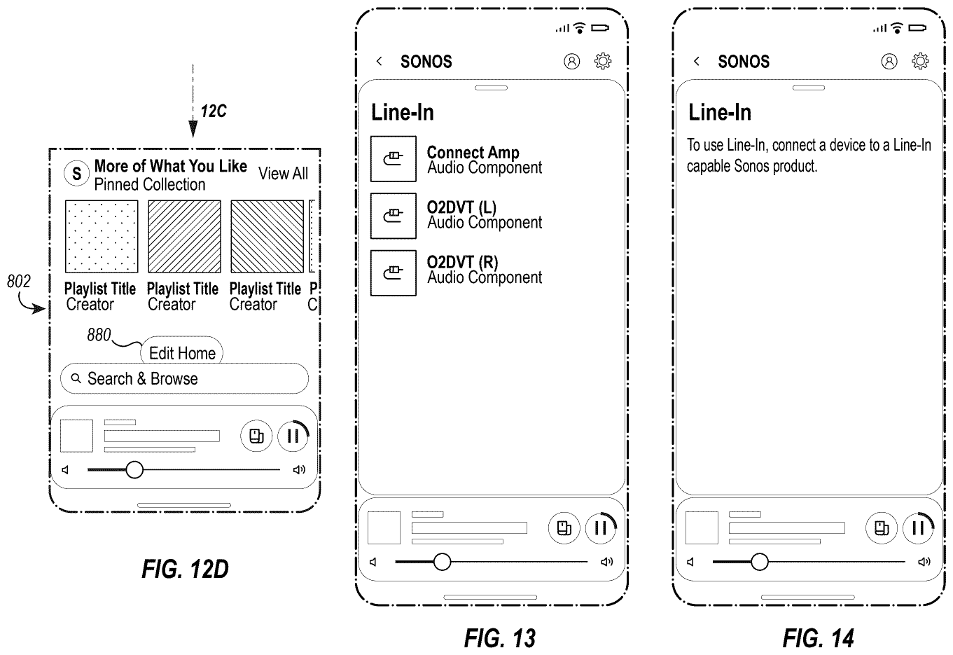

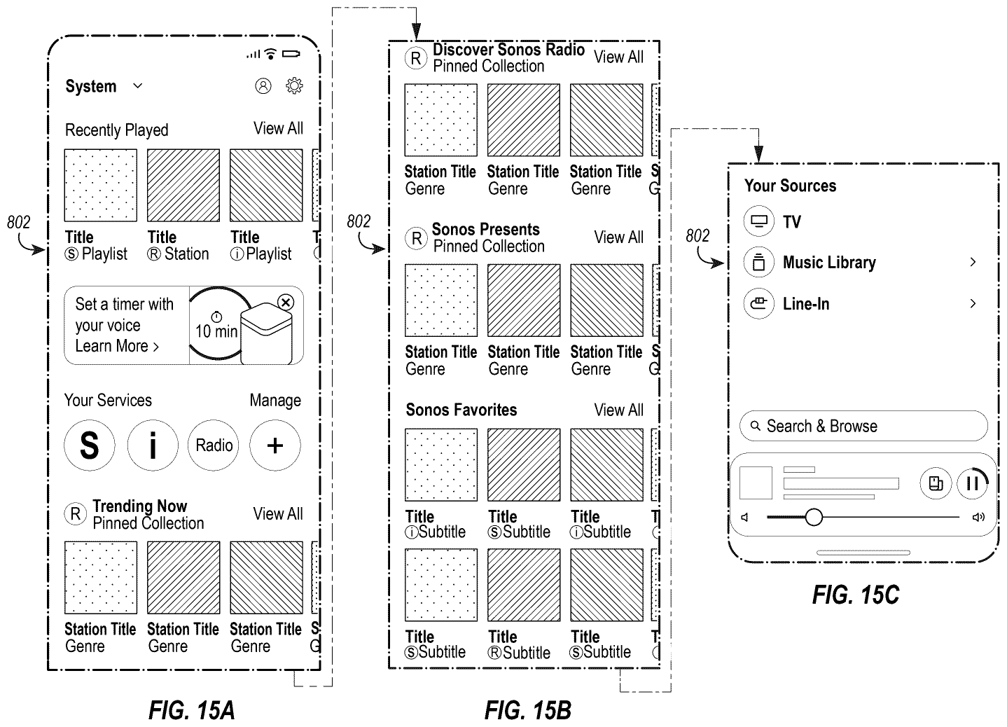

Operational flow diagram 700 illustrates flow proceeding from the Start block to node 1. At node 1, when a state is present indicating the user is a new user with home screen setup complete, the user device may present a graphical user interface display conceptually similar to that shown in FIGS. 8A and 8B (“FIG. 8” as shown in FIG. 7A and used herein refers to FIG. 8A and FIG. 8B; this convention is also used for other Figure references (e.g., FIG. 12 refers to FIGS. 12A through 12D, FIG. 15 refers to FIGS. 15A through 15C, etc.)). For instance, the user device (or the media application executing on the user device) may be linked or otherwise associated with a user profile of a user (e.g., via a sign-in or registration action), which may indicate whether the user profile is new and whether home screen setup has been previously completed. FIGS. 8A and 8B illustrate an example graphical user interface display 800 that includes a media dashboard interface 802. In the example of FIGS. 8A and 8B, the media dashboard interface 802 includes a recently played region 810, a services region 820, a favorites region 830, and a sources region 840. The media dashboard interface 802 can be displayed on the user device as a single navigable page, enabling navigation or scrolling among the regions thereof via user input (e.g., touch and drag input, or other input type).

The services region 820 of the media dashboard interface 802 includes a selectable element 822 that corresponds to a media streaming service. The media streaming service can be associated with the user profile active (e.g., signed in) at the user device (or the media application executing on the user device). The sources region 840 also includes a selectable element 842 that corresponds to an audio signal source connected (e.g., via input/output 111) to a component (e.g., a playback device 110) of the media playback system (e.g., media playback system 100) associated with the user device.

The media dashboard interface 802 also includes pinned collection regions 850. Each of the various pinned collection regions 850 of the media dashboard interface 802 is associated with the media streaming service that corresponds to selectable element 822 of the services region 820 (e.g., the “R” icon of the pinned collection regions 850 indicates that the media content represented in the pinned collection regions 850 is sourced via the media streaming service associated with the “Radio” selectable element 822 of the services region 820). Each pinned collection region 850 includes one or more selectable elements 852 that correspond to media items from the media streaming service associated with selectable element 822. Such selectable elements 852 can provide users with ready access to content from the applicable media streaming service from the media dashboard interface 802. The selectable element(s) 852 of the pinned collection regions 850 of the media dashboard interface 802 are navigable within the media dashboard interface 802. For instance, a pinned collection region 850 can include more selectable elements 852 than are visible in the media dashboard interface 802 at any given moment, and user input directed to the pinned collection region 850 (e.g., touch and drag input, navigation button presses, swipe gestures, voice commands, gaze input, tilt scrolling/motion input, external controller input, etc.) can cause the selectable elements 852 visible in the media dashboard interface 802 to change (e.g., by scrolling left or right within the various pinned collection regions in response to user input).

Although only a single selectable element 822 and 842 is shown for the services region 820 and the sources region 840, respectively, any quantity of selectable elements can be included for these regions (see FIGS. 12A through 12D). When multiple selectable elements 822 or 842 are included in the services region 820 or the sources region 840, respectively, such selectable elements 822 or 842 can be presented in navigable form (e.g., similar to the selectable elements 852 of the pinned collection regions 850 described above).

Additional details related to the recently played region 810 and the favorites region 830 will be discussed hereinafter.

The media dashboard interface 802 furthermore includes a search and browse selectable element 804, the selection of which can cause presentation of or navigation to a search and browse interface. The search and browse interface can enable a user to provide user input that defines or indicates a search query for searching among media content available to the applicable user profile.

Referring again to FIG. 7A, operational flow diagram 700 illustrates flow proceeding from the presentation of FIG. 8 (after node 1) to node 2. At node 2, when a state is present indicating the user listens to content, the user device may present a graphical user interface conceptually similar to that shown in FIG. 8 as well, which may include presentation of a now playing bar 860 simultaneously with the media dashboard interface 802 (the now playing bar 860 can be omitted if no content has been listened to). FIG. 8B illustrates the now playing bar 860 as including a media information region 862, a play/pause element 864, a progress tracking element 866, a volume control element 868, and a grouping control element 870. The media information region 862 can display information associated with the media item/content currently being played by the media playback system (e.g., media playback system 100) associated with the user device. For instance, the media information region 862 can display title information, artist/creator information, album information, etc. The play/pause element 864 can be selectable to facilitate playing or pausing of the media item currently being played (or enqueued to be played). The volume control element 868 can be selectable or interactable to facilitate volume changes for playback of the media item currently being played (or enqueued to be played).

The progress tracking element 866 of the now playing bar 860 provides a visual representation of the playback progress of the media item currently being played (or enqueued to be played) by one or more playback devices (e.g., playback devices 110) of the media playback system (e.g., media playback system 100) associated with the user device. The visual representation of the playback progress shown in the now playing bar 860 of FIG. 8B includes visual changing of the perimeter around the play/pause element 864. In the example of FIG. 8B, the play/pause element 864 has a circular perimeter, and the progress tracking element 866 visually fills, colorizes, emboldens, or otherwise changes the appearance of the perimeter of the play/pause element 864 as the playback of the media item progresses to visually indicate the playback progress of the media item. Although a circular perimeter for the play/pause element 864 is shown in FIG. 8B, other perimeter shapes are within the scope of the present disclosure. In some instances, the progress tracking element 866 of the now playing bar 860 can visually depict the playback progress of the media item being played by visually changing the area of the play/pause element 864 (e.g., gradual filling of the area of the play/pause element 864 that tracks with playback progress).

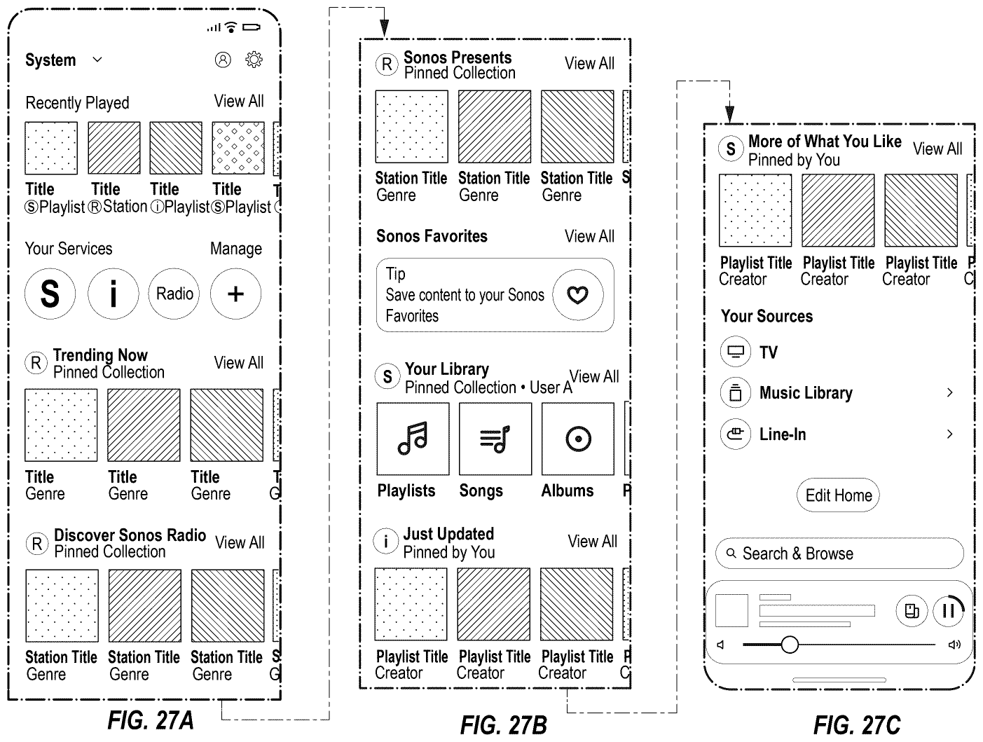

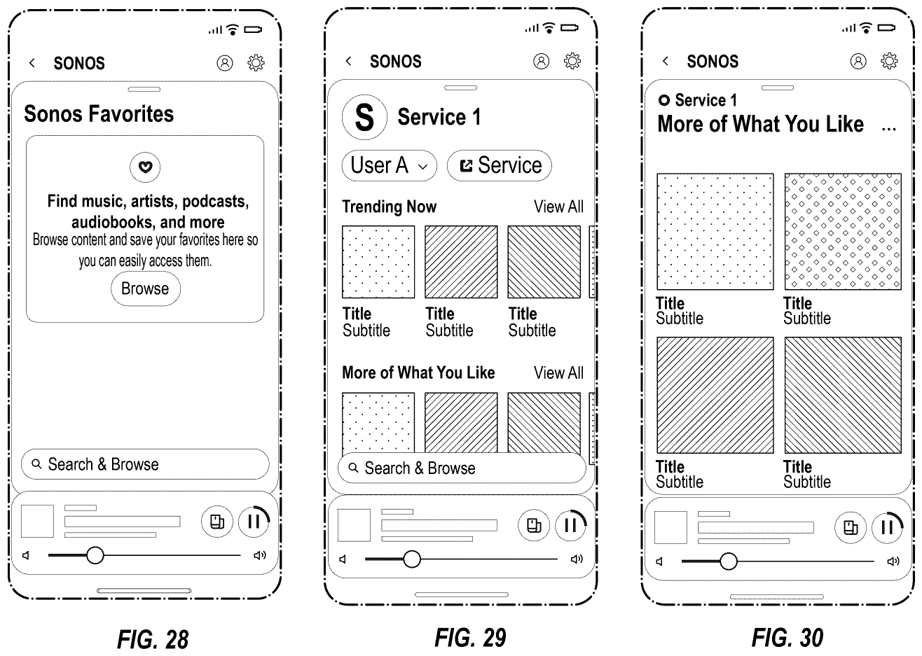

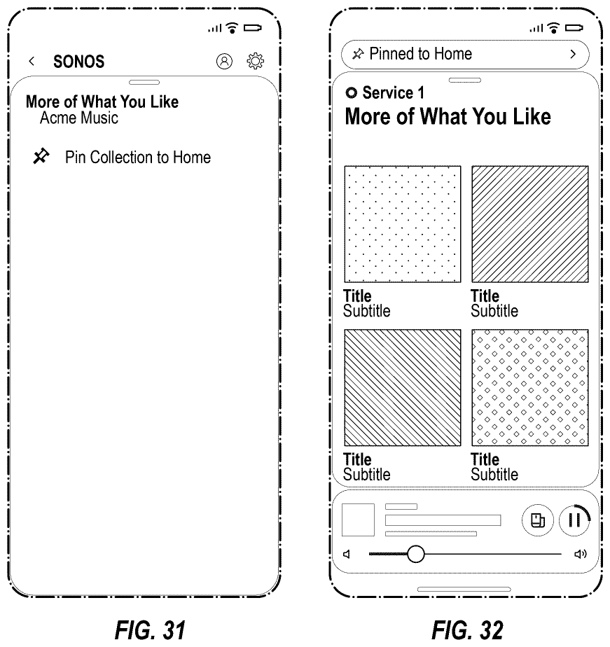

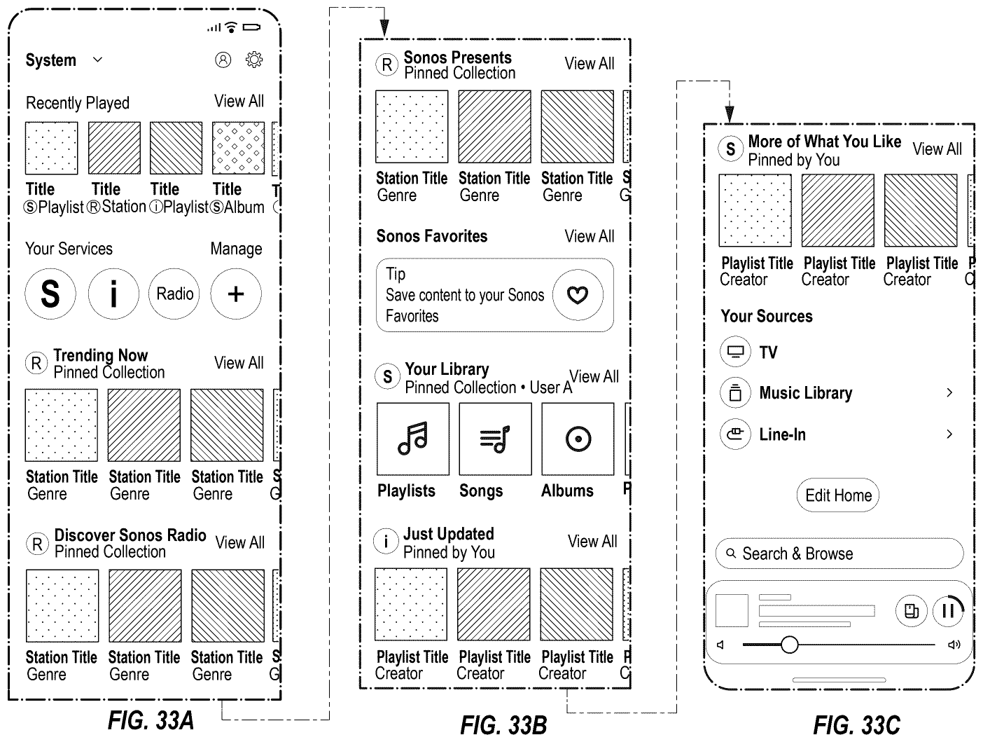

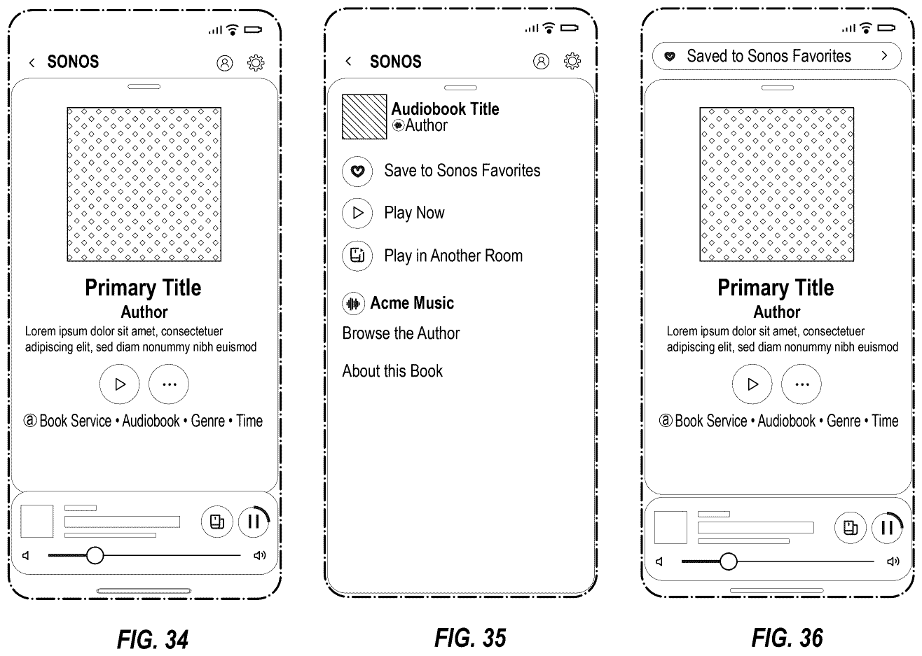

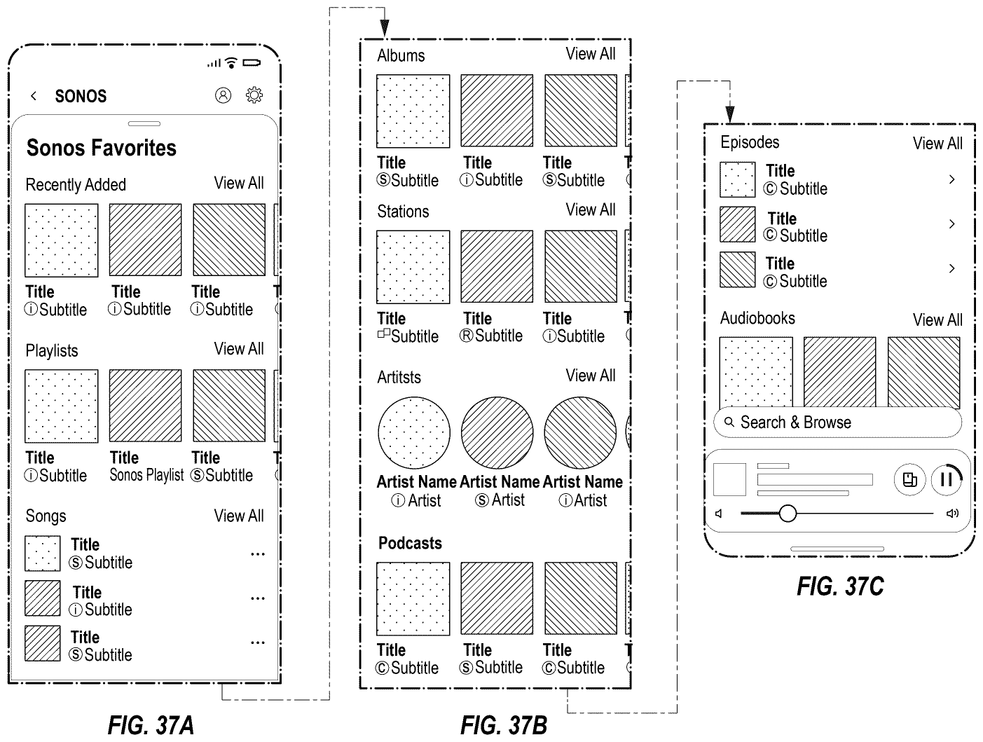

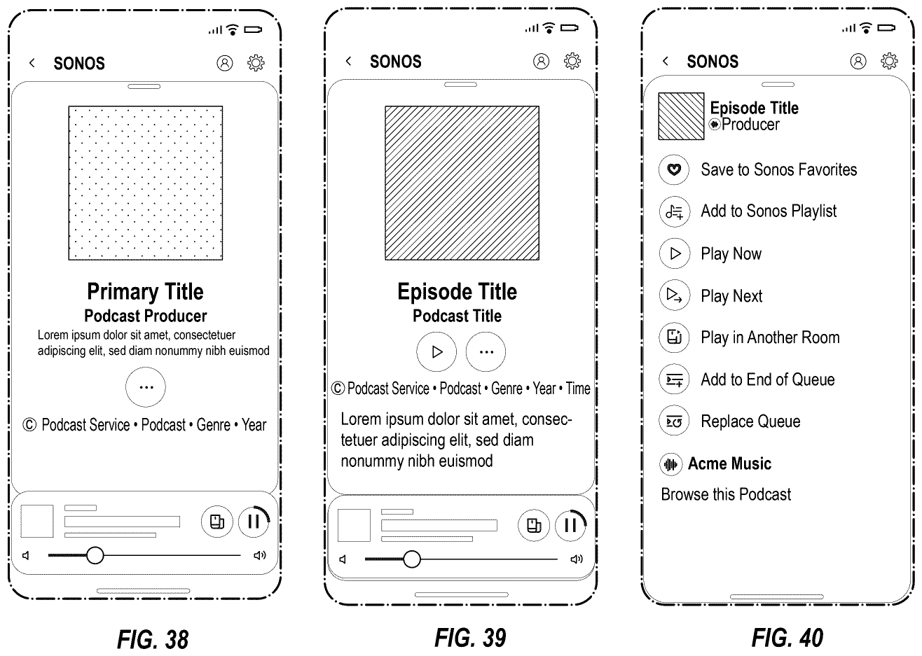

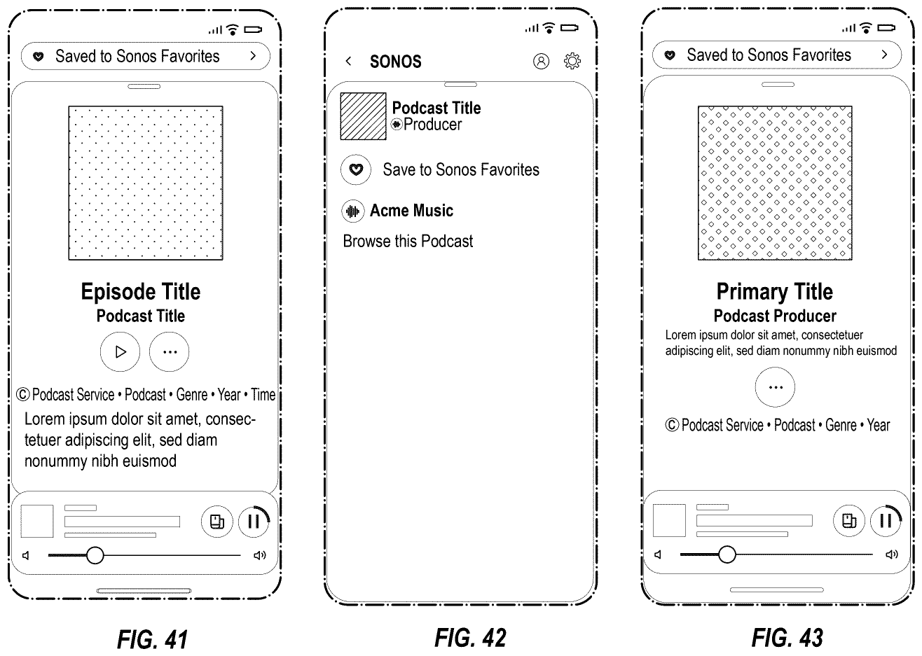

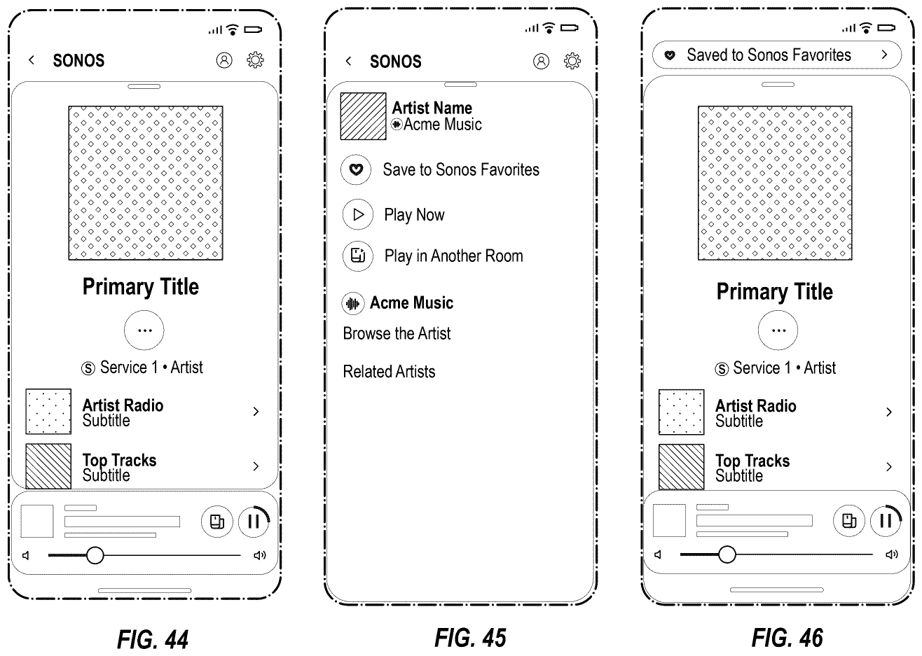

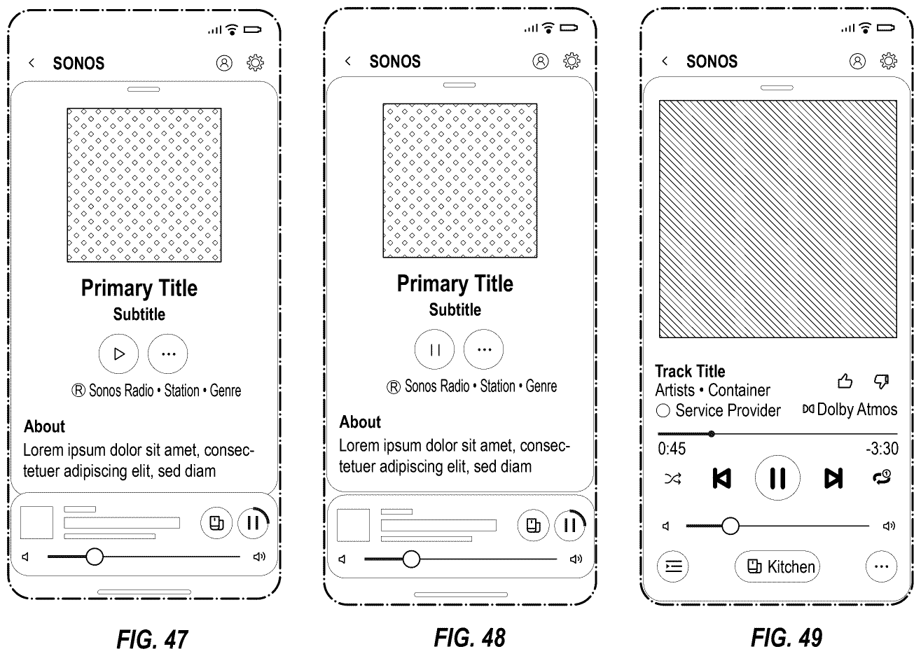

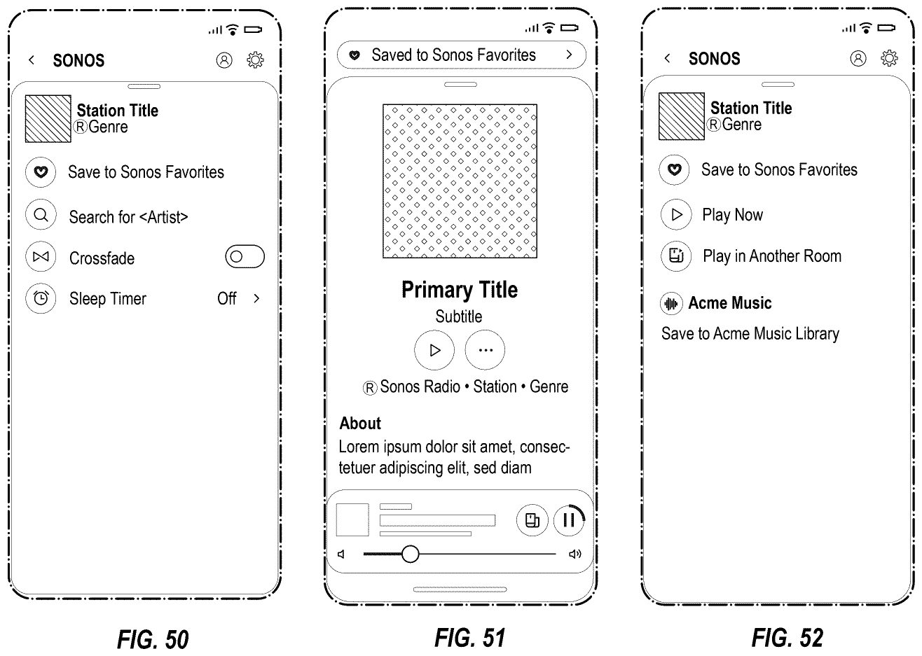

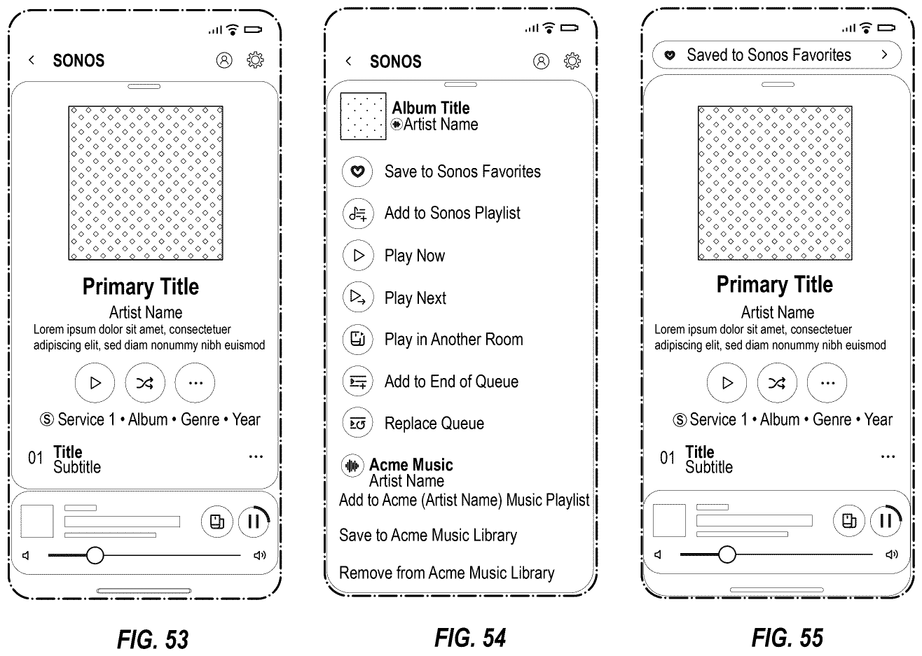

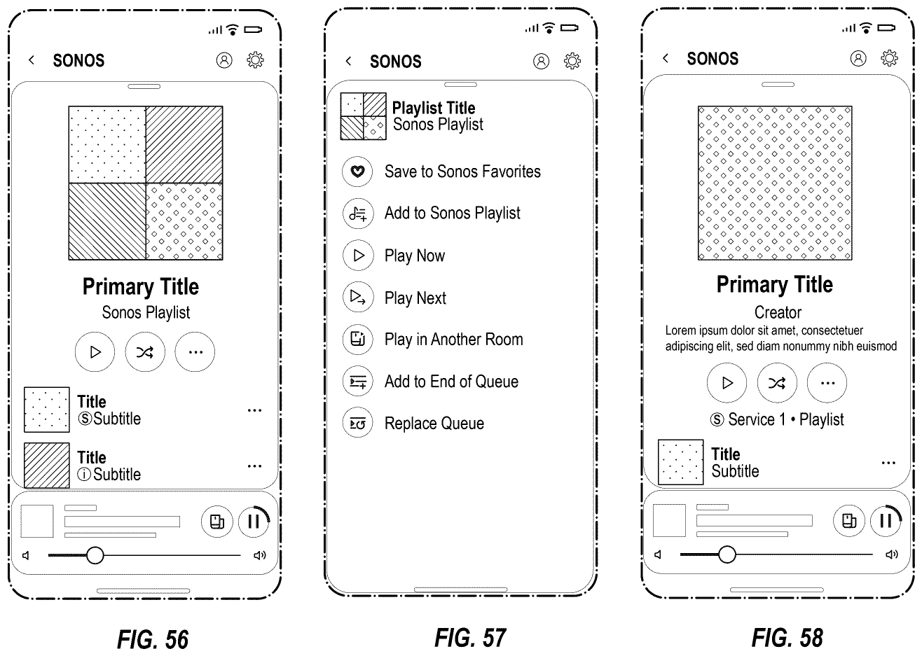

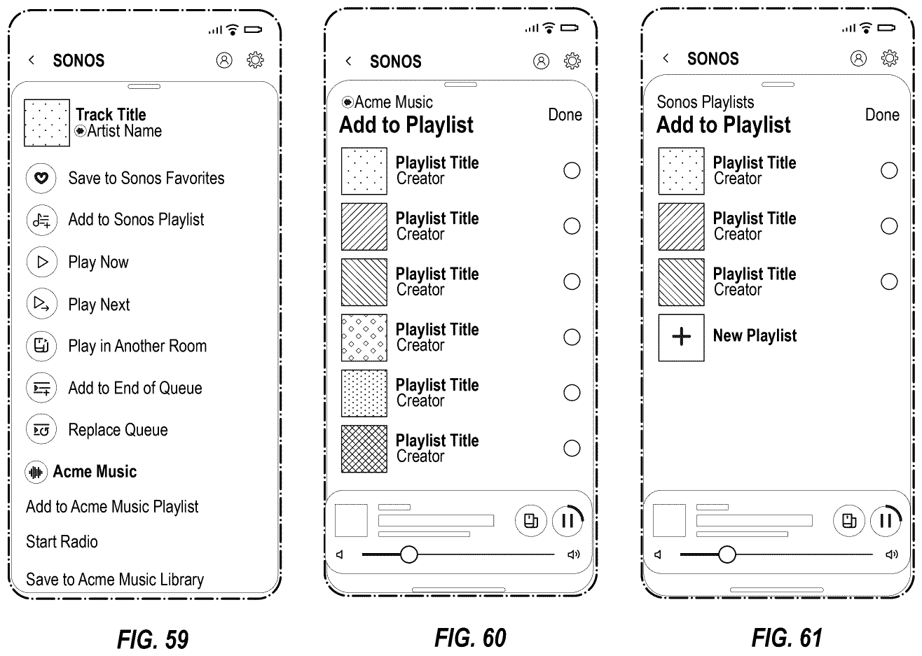

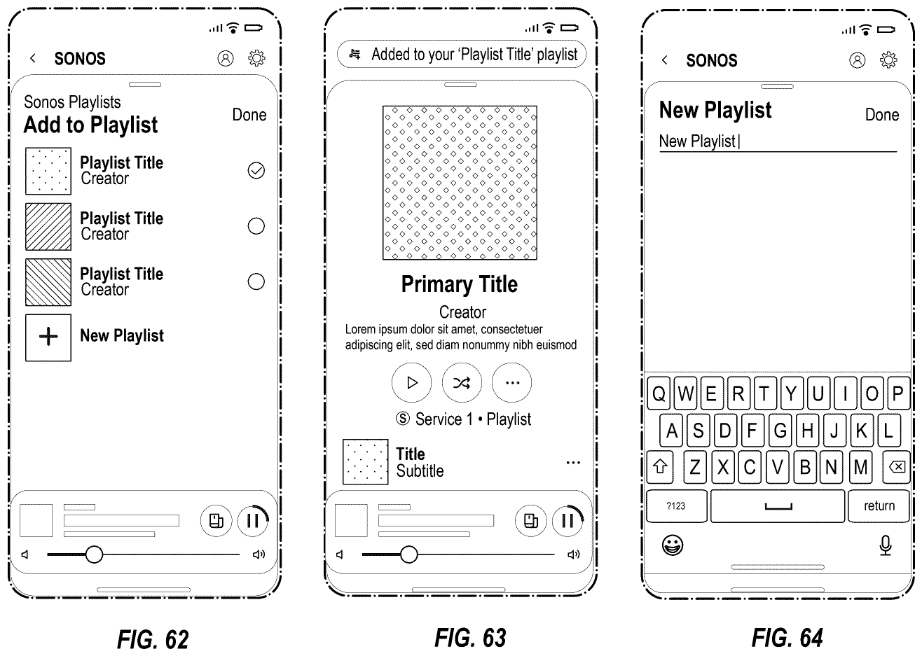

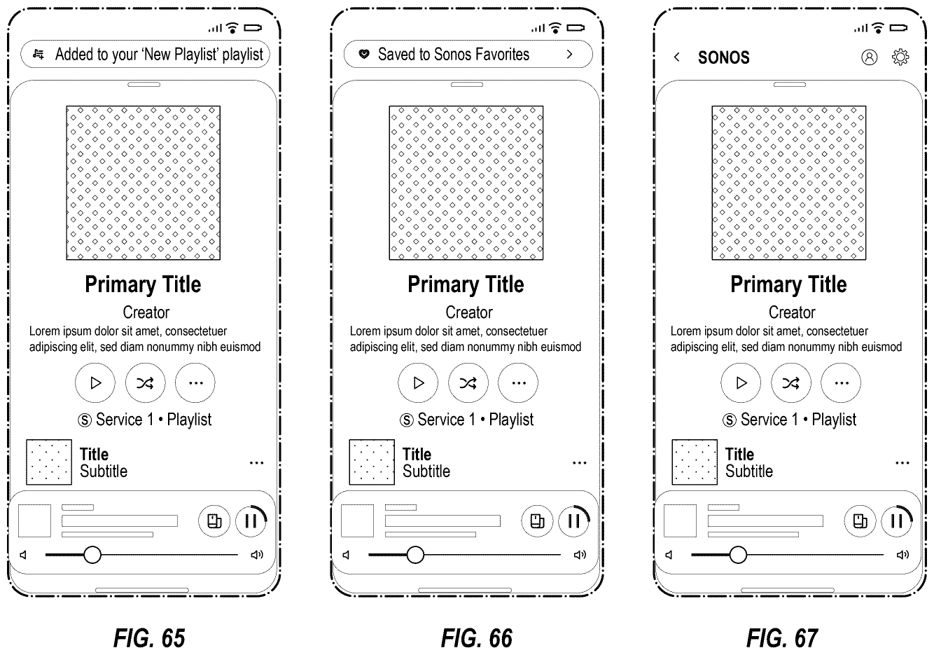

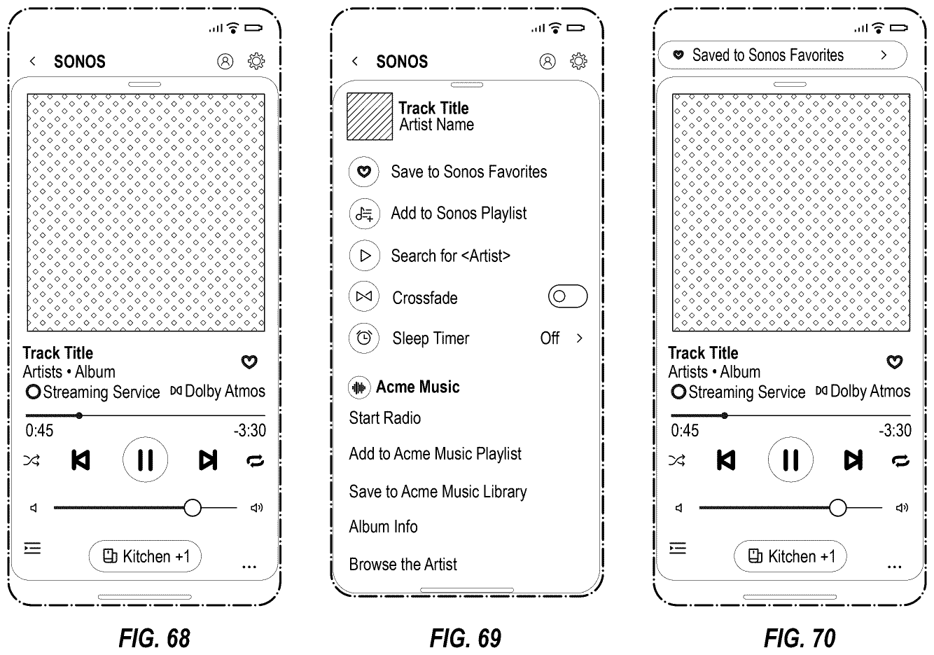

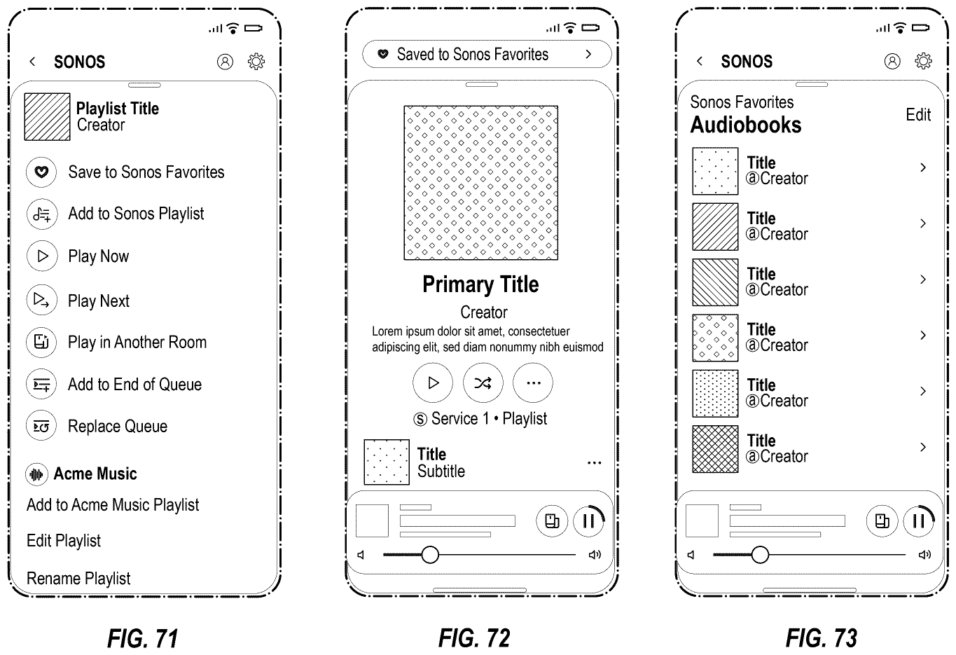

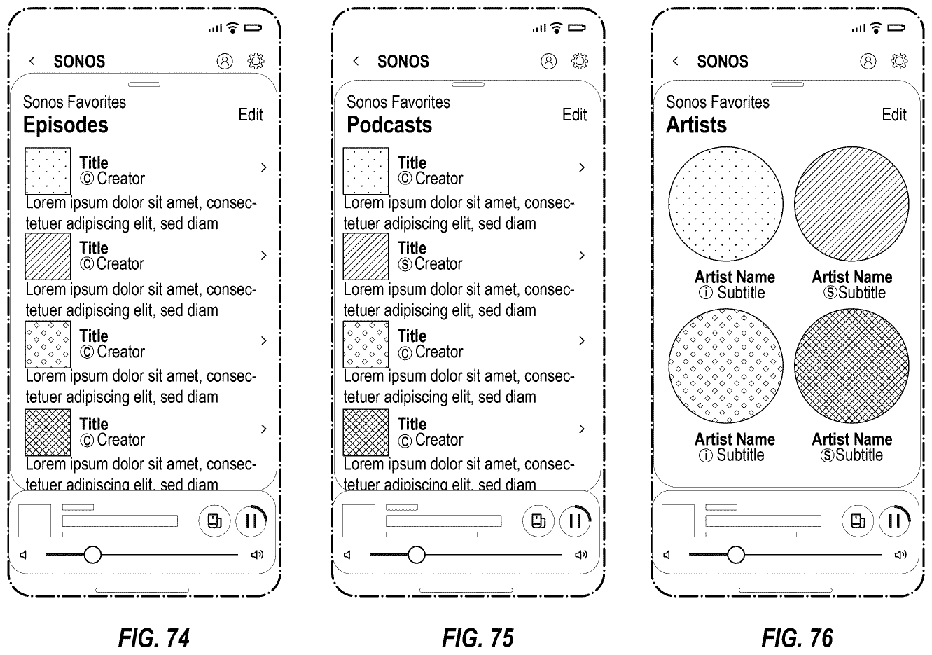

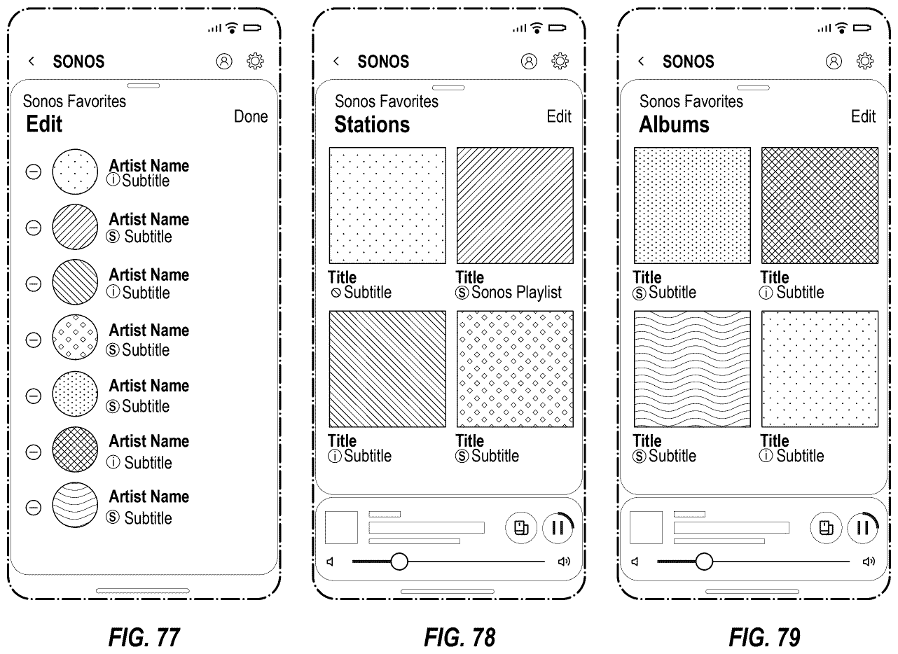

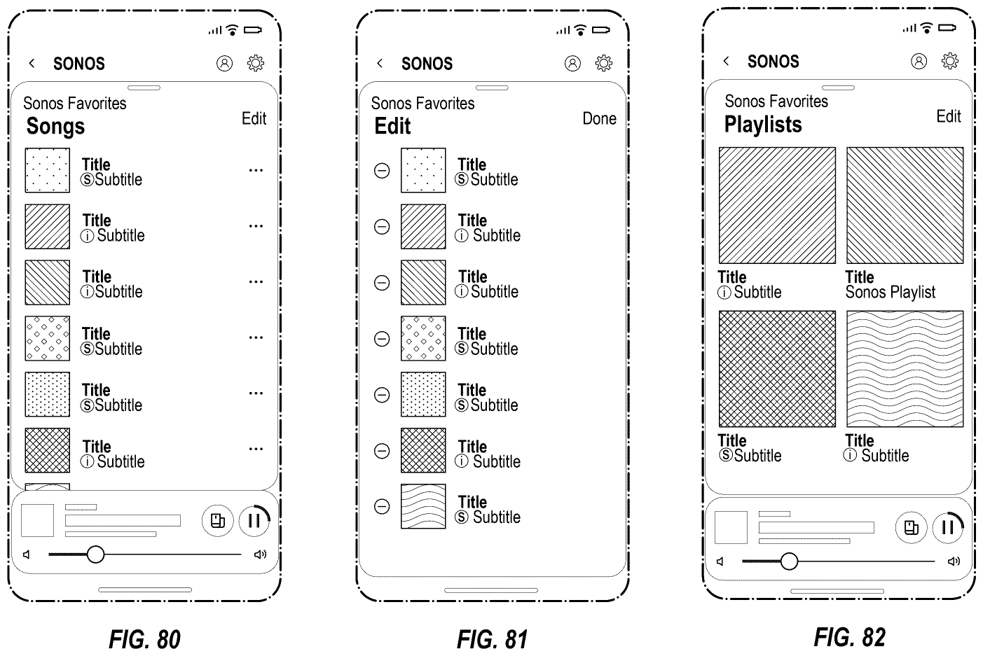

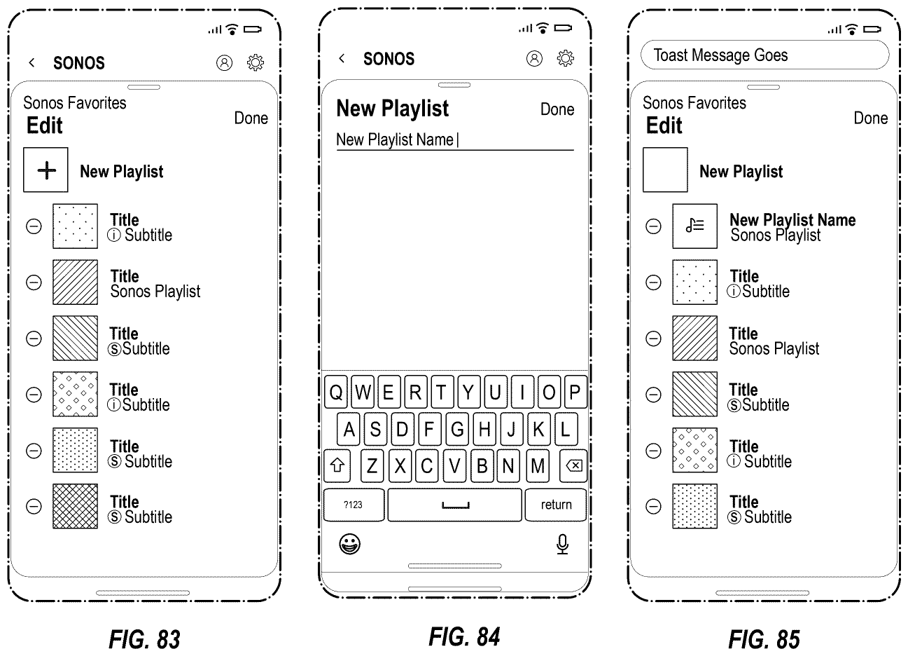

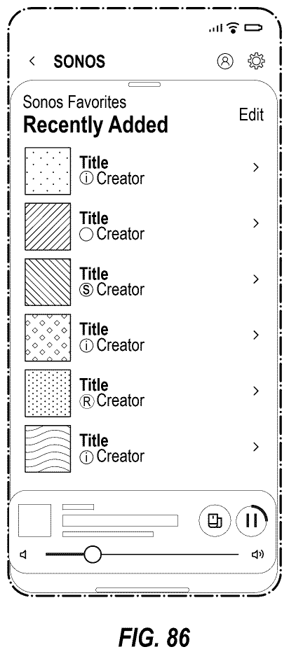

Although FIG. 8B illustrates the now playing bar 860 as being presented simultaneously with the media dashboard interface 802, the now playing bar 860 may be presented simultaneously with other interfaces displayable on the user device, such as a recently played content interface (see FIGS. 17 and 18), a service management interface, a favorite content interface (see FIGS. 27A through 86), or a search and browse interface.

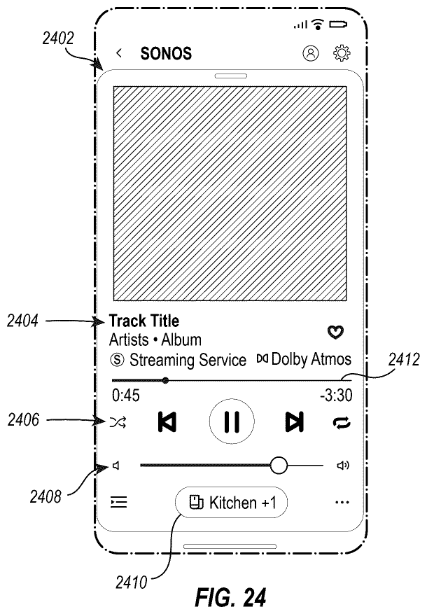

In some instances, after the user device detects user input directed to the now playing bar 860 (e.g., a tap or a long press directed to the media information region 862 or another portion of the now playing bar 860), the user device can present a now playing interface. FIG. 24 illustrates an example now playing interface 2402, which includes a media information region 2404, a playback control region 2406 (e.g., include a play/pause element, skip forward and backward elements, repeat and shuffle elements, etc.), a volume control element 2408, a grouping control element 2410, and a progress tracking element 2412. The progress tracking element 2412 can provide a different visual representation of the playback progress of the current media item than the progress tracking element 866 described above with reference to FIG. 8B. For instance, the progress tracking element 2412 of FIG. 24 depicts track progress by visually changing (e.g., filling, highlighting, emboldening, etc.) a linear space that is spatially offset from the playback control region 2406 (in particular from the play/pause element thereof). Alternative representations of track progress can thus be provided in a now playing bar 860 and a now playing interface 2402 of a media application operated on a user device.

In some implementations, the progress tracking element 2412 can enable navigation or scrubbing to different progress points for the current media item (e.g., via user input directed to a part of the linear space of the progress tracking element 2412 that corresponds to a desired timepoint in the current media item), while the progress tracking element 866 may lack such functionality.

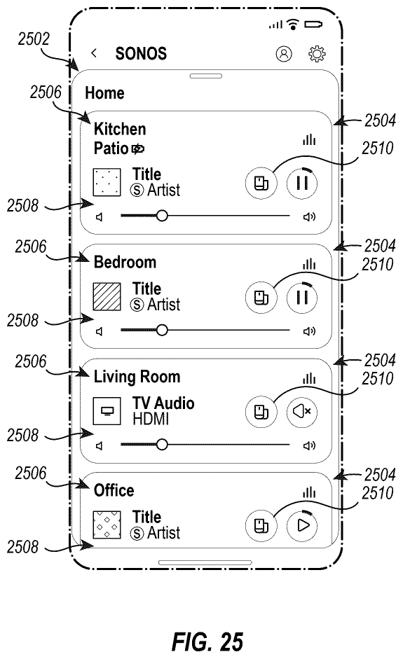

In some embodiments, the user device displays a system control interface (or system control screen or grouping control interface/screen or rooms interface/screen/menu or zone interface/screen/menu) after receiving user input directed to the grouping control element 870, the grouping control element 2410, or another element (e.g., system control element 806, see FIG. 8A). FIG. 25 illustrates an example system control interface 2502, which includes different groupings 2504 of playback devices (e.g., playback devices 110) of the media playback system (e.g., media playback system 100) associated with the user device. The groupings 2504 of playback devices can comprise zones of playback devices (e.g., playback zones) as described hereinabove and in U.S. patent application Ser. No. 14/205,343 filed Mar. 11, 2014, and entitled “Playback Zone Representations,” the entirety of which is incorporated herein by reference for all purposes. In the example of FIG. 25, each grouping 2504 includes a room name 2506, media information 2508 (which can include media information for current or recent media items, a play/pause element, a progress tracking element integrated with the play/pause element, a volume control element for controlling volume of the entire group/zone, etc.), and a group configuration element 2510 (e.g., selection of which can surface a group configuration interface for defining which playback devices are grouped together to form a playback zone).

Referring again to FIG. 7A, operational flow diagram 700 illustrates flow proceeding from node 2 and from the presentation of FIG. 8 (after node 2) to an “Add Services Flow” when user input has been detected for adding a service to the services region 820 (e.g., “Tap On ‘+’ (Add Icon) Under Your Services To Add Services”). FIG. 8A illustrates the add icon 824 of the services region 820. After selection of the add icon 824, the user device can present an add services flow to enable the user to link services to the media application for presentation as a selectable element 822 in the services region 820 (e.g., by selecting a partnered media service and providing credentials).

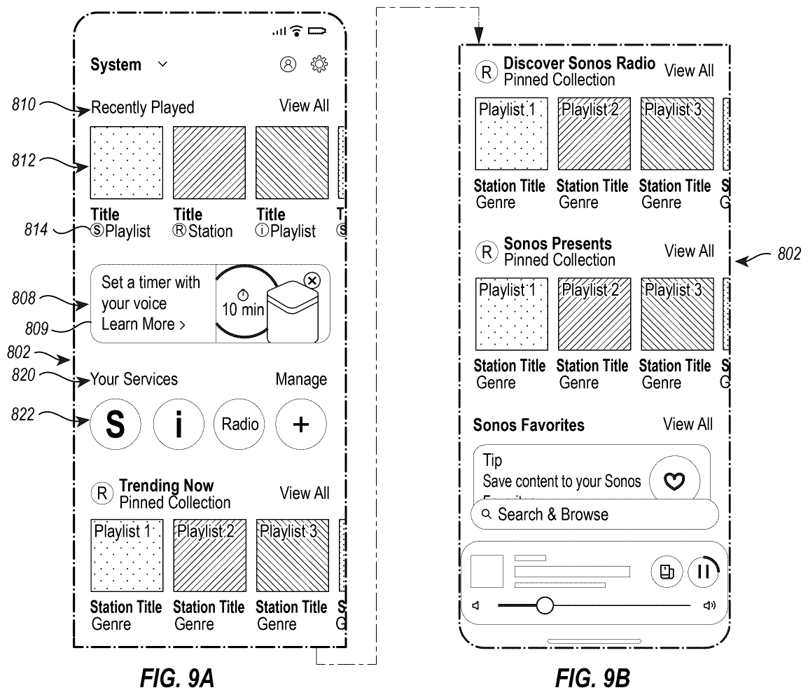

Operational flow diagram 700 illustrates that, after completion of the add services flow, the user device may present a graphical user interface display conceptually similar to that shown in FIG. 9 (FIGS. 9A and 9B). FIGS. 9A and 9B illustrate the media dashboard interface 802 with additional selectable elements 822 corresponding to additional media streaming services included in the services region 820. FIGS. 9A and 9B also illustrates selectable elements 812 included in the recently played region 810 of the media dashboard interface 802. The selectable elements 812 of the recently played region 810 can correspond to individual media items recently played by one or more playback devices (e.g., playback devices 110) of the media playback system (e.g., media playback system 100) to which the user device is connected. Similar to the selectable elements 852 of the pinned collection regions 850, the selectable elements 812 of the recently played region 810 may be navigable within the media dashboard interface 802. Each selectable element 812 of the recently played region 810 can be presented with a respective media streaming service indicator 814, which can indicate the media streaming service from which the media item associated with the selectable element 812 is sourced.

FIGS. 9A and 9B furthermore illustrate the media dashboard interface 802 as including a recommended action region 808, which includes a selectable element 809 that corresponds to recommended actions for configuring or operating one or more components of the media playback system (e.g., media playback system 100) associated with the user device. In the example of FIG. 9A, the selectable element 809 of the recommended action region 808 corresponds to setting a voice timer, though other recommended actions may be presented (e.g., setting up a voice assistant, setting up a high-definition radio service, connecting surrounds to a room/zone/grouping, etc.).

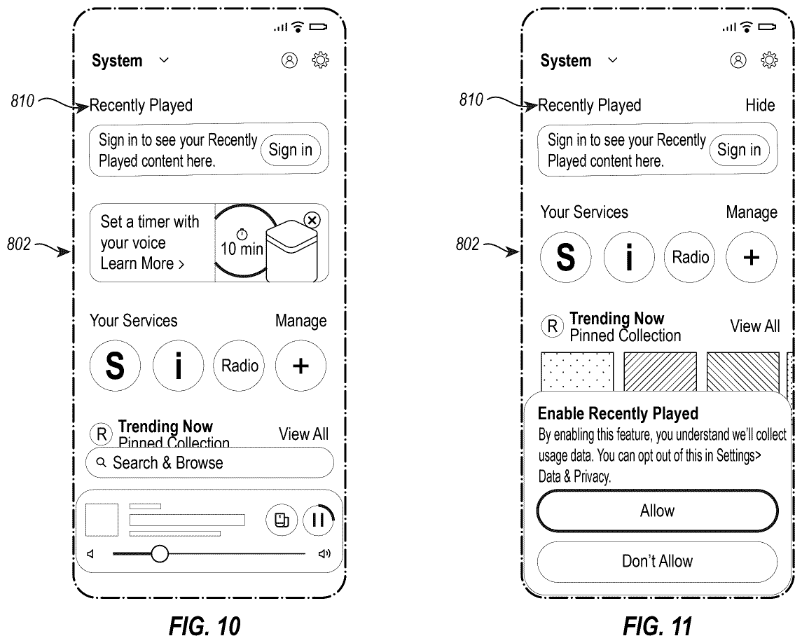

Operational flow diagram 700 illustrates flow proceeding from node 1 to node 3 when a state is present indicating the user is an existing user. At node 3, when a state is present indicating ‘personalized services’ settings are not enabled, the user device may present a graphical user interface display conceptually similar to that shown in FIG. 10, which illustrates an example media dashboard interface 802 with no selectable elements corresponding to recently played media items in the recently played region 810. Operational flow diagram 700 illustrates flow proceeding from the presentation of FIG. 10 (after node 3) to the user device presenting a graphical user interface display conceptually similar to that shown in FIG. 11 when user input has been detected for turning on the personalized services settings (e.g., “Tap On ‘Turn On’”). The user input for turning on the personalized services settings can be directed to the recently played region 810 or another region/element. FIG. 11 illustrates a prompt for user input indicating whether to enable functionality of the recently played region 810 within the media dashboard interface 802.

Operational flow diagram 700 illustrates flow proceeding from node 3 to node 4 when a state is present indicating ‘personalized services’ settings are enabled. At node 4, when a state is present indicating the user is signed out, the user device may present a graphical user interface display conceptually similar to that shown in FIG. 10. At node 4, when a state is present indicating the user is signed in, flow may proceed to node 5. At node 5, when a state is present indicating the user has no favorited content from a previous software iteration (e.g., a previous version or iteration of the media application) or has not added content to the favorites region 830, the user device may present a graphical user interface display conceptually similar to that shown in FIG. 9 (FIGS. 9A and 9B). At node 5, when a state is present indicating the user has favorited content from a previous software iteration or has added content to the favorites region 830, flow may proceed to node 6. Node 6 of the operational flow diagram 700 is shown in FIG. 7B, with linking node “AA” representing a link between the part of the operational flow diagram 700 shown in FIG. 7A and the part of the operational flow diagram 700 shown in FIG. 7B.

At node 6, when a state is present indicating line-in capable and/or TV products are present in the media system associated with the user device, the user device may present a graphical user interface display conceptually similar to that shown in FIG. 12 (FIGS. 12A through 12D). FIG. 12B illustrates selectable elements 832 included in the favorites region 830 of the media dashboard interface 802. The selectable elements 832 of the favorites region 830 can correspond to flagged media items (e.g., media items marked or treated as favorites in an applicable/active user profile). Similar to the selectable elements 852 of the pinned collection regions 850, the selectable elements 832 of the favorites region 830 may be navigable within the media dashboard interface 802. Each selectable element 832 of the favorites region 830 can be presented with a respective media streaming service indicator 834, which can indicate the media streaming service from which the media item associated with the selectable element 832 is sourced.

FIG. 12D also illustrates the media dashboard interface 802 as including an edit home selectable element 880, the selection of which can cause presentation of or navigation to an editing interface for adding regions, removing regions, or editing regions for the media dashboard interface 802 (see FIGS. 20-23).

Operational flow diagram 700 illustrates flow proceeding from presenting FIG. 12 to node 7. At node 7, when a state is present indicating a connected line-in audio source is available, the user device may present a graphical user interface display conceptually similar to that shown in FIG. 13, which prompts the user to identify a line-in audio source to utilize for audio playback. At node 7, when a state is present indicating that no line-in audio source is available, the user device may present a graphical user interface display conceptually similar to that shown in FIG. 14, which prompts the user to connect a line-in capable device to achieve line-in playback functionality.

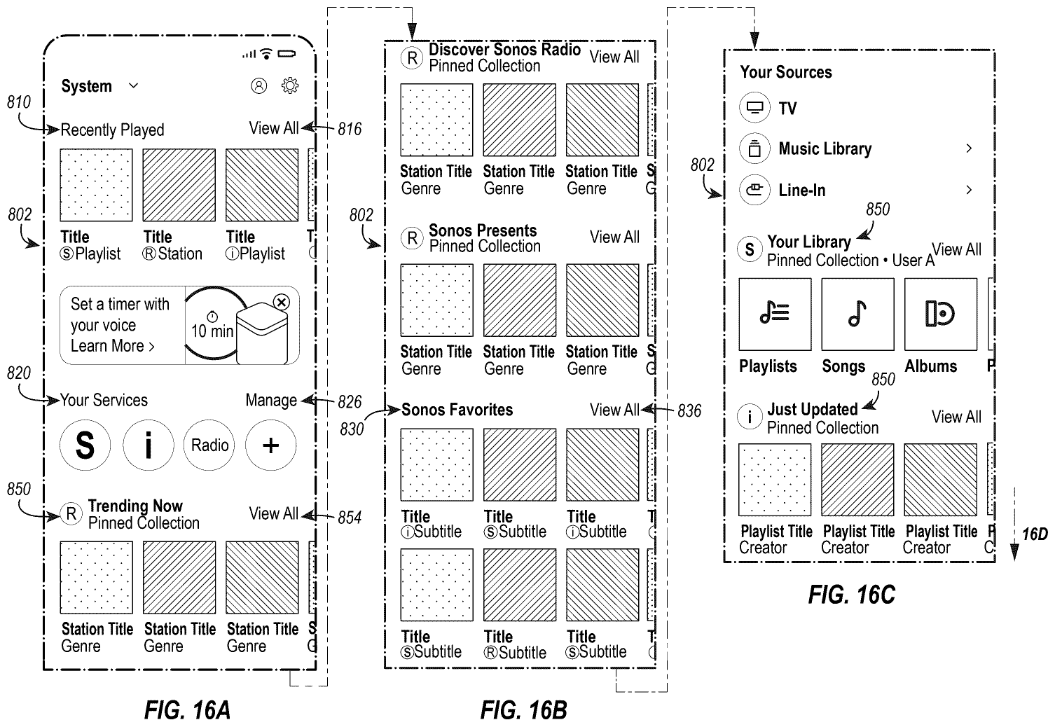

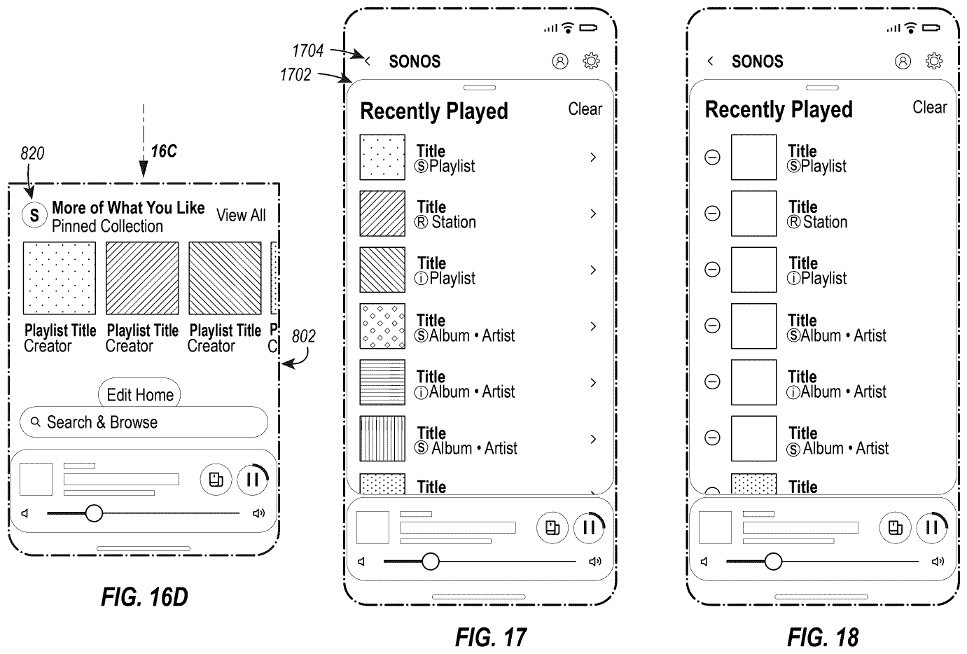

Operational flow diagram 700 illustrates flow proceeding from node 6 to node 8 when a state is present indicating line-in capable and/or TV products are not present in the media system associated with the user device. At node 8, when a state is present indicating that no containers/regions have been added/pinned to home (e.g., to the media dashboard interface 802), the user device may present a graphical user interface display conceptually similar to that shown in FIG. 15 (FIGS. 15A through 15C). At node 8, when a state is present indicating that containers/regions have been added/pinned to home, the user device may present a graphical user interface display conceptually similar to that shown in FIG. 16 (FIGS. 16A through 16D), which illustrates additional pinned collection regions 850 in the media dashboard interface 802 associated with various services represented in the services region 820.

Operational flow diagram 700 illustrates flow proceeding from presentation of FIG. 15 and FIG. 16 to node 9. At node 9, flow proceeds to node 10 when user input has been detected selecting a “View All” selectable element for a container/region of the media dashboard interface 802 (e.g., “Tap On Container “View All””). FIGS. 16A through 16D illustrate a “view all” selectable element 816 of the recently played region 810 and a “view all” selectable element 854 of a pinned collection region 850 of the media dashboard interface 802.

At node 10, after selection of the “view all” selectable element 816 for the recently played region 810 (e.g., “Tap On Recently Played “View All” Button), the user device may present a graphical user interface display conceptually similar to that shown in FIG. 17, which illustrates a recently played content interface 1702 (and omits the media dashboard interface 802). The recently played content interface 1702 includes a return selectable element 1704, the selection of which can trigger a return to the media dashboard interface 802. The recently played content interface 1702 can display an expanded list of recently played media items (e.g., including additional recently played media items relative to the recently played region 810 shown in the media dashboard interface 802). In some instances, user input directed to the recently played content interface 1702 (e.g., a long press on a media item, or selection of an edit selectable element) can cause presentation of an edit screen, illustrated in FIG. 18.

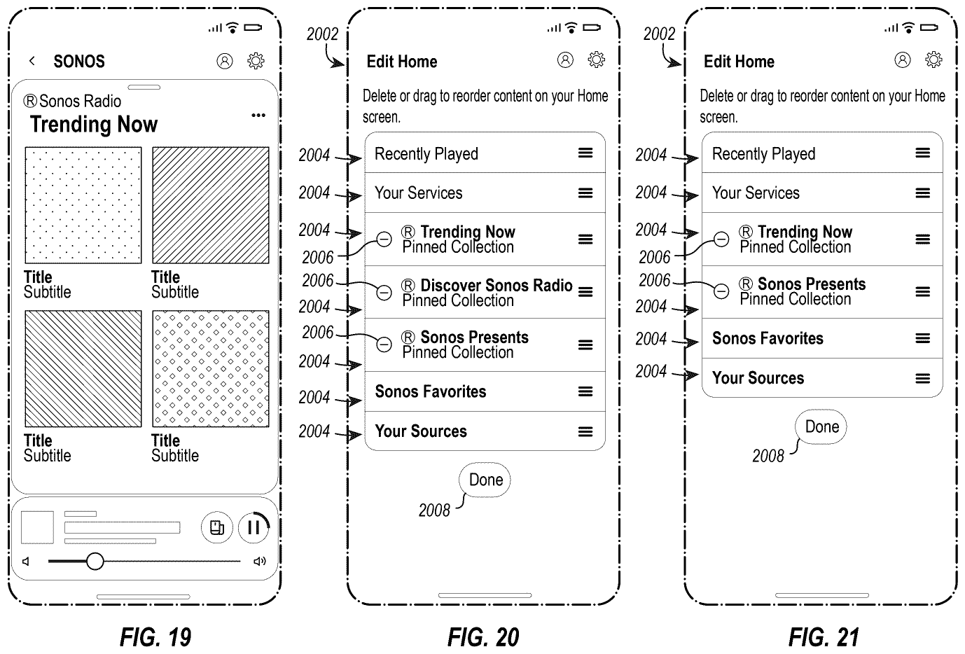

At node 10, after selection of the view all selectable element 854 of a pinned collection region 850 (e.g., “Tap On Other Container “View All” Button”), the user device may present a graphical user interface display conceptually similar to that shown in FIG. 19, which illustrates an expanded view of media items related to the pinned collection region 850 for which the view all selectable element 854 was selected (e.g., in grid format, rather than the list format shown in FIG. 17).

Operational flow diagram 700 illustrates flow proceeding from node 9 to node 11 for states that do not cause flow to proceed to node 10. At node 11, the user device may present a service management interface when user input has been detected selecting a manage selectable element 826 of a services region 820 of a media dashboard interface 802 (e.g., “Tap On “Manage” Button For Your Services”). FIG. 16A illustrates the “manage” selectable element 826 of the services region 820 of the media dashboard interface 802. The service management interface can enable reconfiguration or modification of media streaming services linked to the media application. Similar to the recently played content interface 1702, the service management interface can be displayed while refraining from displaying the media dashboard interface 802, and the service management interface can include a return selectable element, the selection of which can trigger a return to the media dashboard interface 802.

Operational flow diagram 700 illustrates flow proceeding from node 11 to node 12 for states that do not include selection of a manage selectable element 826. At node 12, the user device may present a favorite content interface when user input has been detected selecting a “view all” selectable element of a favorites region 830 of a media dashboard interface 802 (e.g., “Tap On Favorites “View All””). FIG. 16B illustrates the view all selectable element 836 of the favorites region 830 of the media dashboard interface 802. FIGS. 27A through 86 illustrate various aspects of a favorite content interface of a media application. Similar to the recently played content interface 1702, the favorite content interface can be displayed while refraining from displaying the media dashboard interface 802, and the favorite content interface can include a return selectable element, the selection of which can trigger a return to the media dashboard interface 802.

Operational flow diagram 700 illustrates flow proceeding to node 13 when user input has been detected selecting an edit home selectable element 880 of a media dashboard interface 802 (e.g., “Tap On “Edit Home””). FIG. 12D illustrates the edit home selectable element 880 of the media dashboard interface 802. At node 13, when a state is present indicating that no containers/regions are added/pinned to home, the user device may present a graphical user interface display conceptually similar to that shown in FIG. 20, which illustrates an editing interface 2002 for the media dashboard interface 802. The editing interface 2002 of FIG. 20 includes representations 2004 of regions/containers of the media dashboard interface 802, which can be interactable to facilitate editing of the media dashboard interface 802. For instance, the representations 2004 of the editing interface 2002 include menu icons (sets of three horizontal bars on the right) that can be used to change the ordering of the representations 2004 (which can cause a corresponding reordering in the media dashboard interface 802). Alternatively, long pressing on the representations 2004 can be used to initiate dragging and dropping functionality to re-order the representations 2004. The editing interface 2002 also includes remove buttons 2006 on various representations 2004, which can be selected to facilitate removal of the representations 2004 (which can cause a corresponding removal from the media dashboard interface 802). Similar to the recently played content interface 1702, the editing interface 2002 can be displayed while refraining from displaying the media dashboard interface 802, and the editing interface 2002 can include a return selectable element 2008, the selection of which can trigger a return to the media dashboard interface 802.

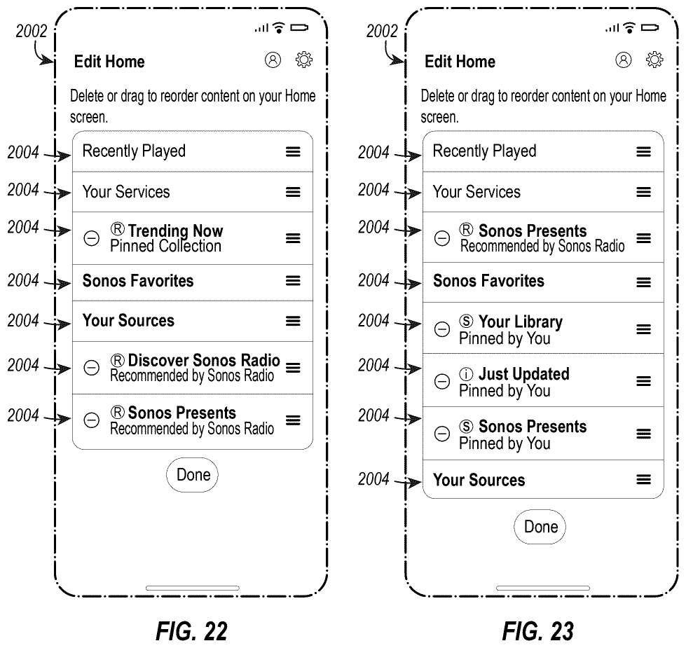

At node 14, when user input has been detected selecting a remove button 2006 of the editing interface 2002 (e.g., “Tap On Remove Button”), the user device may present a graphical user interface display conceptually similar to that shown in FIG. 21, with a representation 2004 removed from the editing interface 2002. At node 14, when user input has been detected for reordering representations 2004 of the editing interface 2002 (e.g., “Long Press To Drag And Drop Or Press The Menu Icon On The Right To Change Order”), the user device may present a graphical user interface display conceptually similar to that shown in FIG. 22, with the representations 2004 of the editing interface 2002 reordered.

At node 13, when a state is present indicating that containers/regions are added/pinned to home, the user device may present a graphical user interface display conceptually similar to that shown in FIG. 23, which illustrates an editing interface 2002 for the media dashboard interface 802 that includes additional representations 2004 relative to FIG. 20.

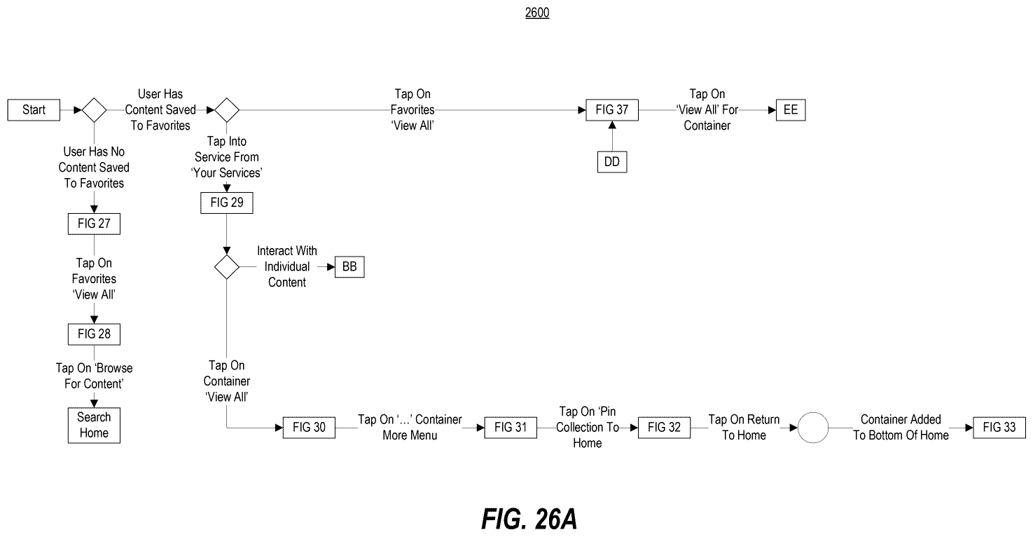

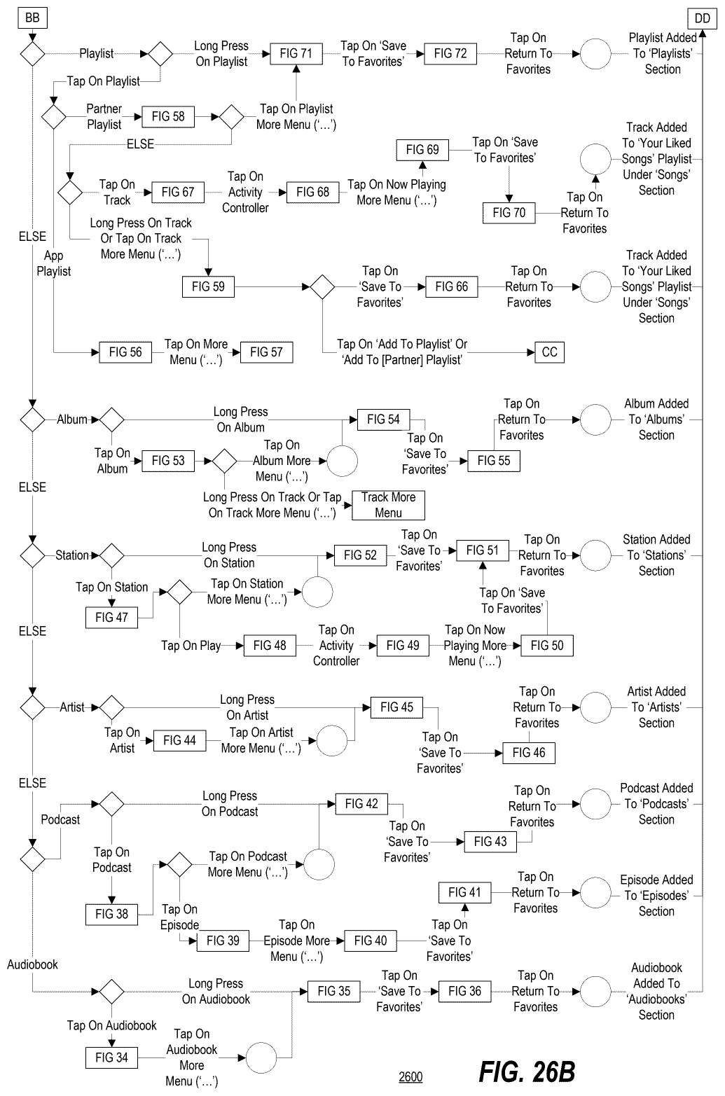

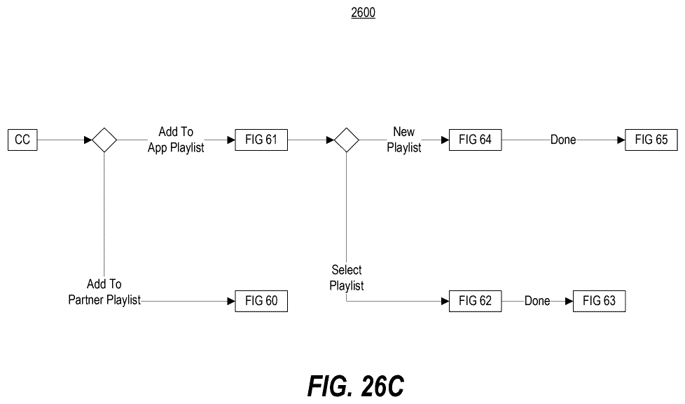

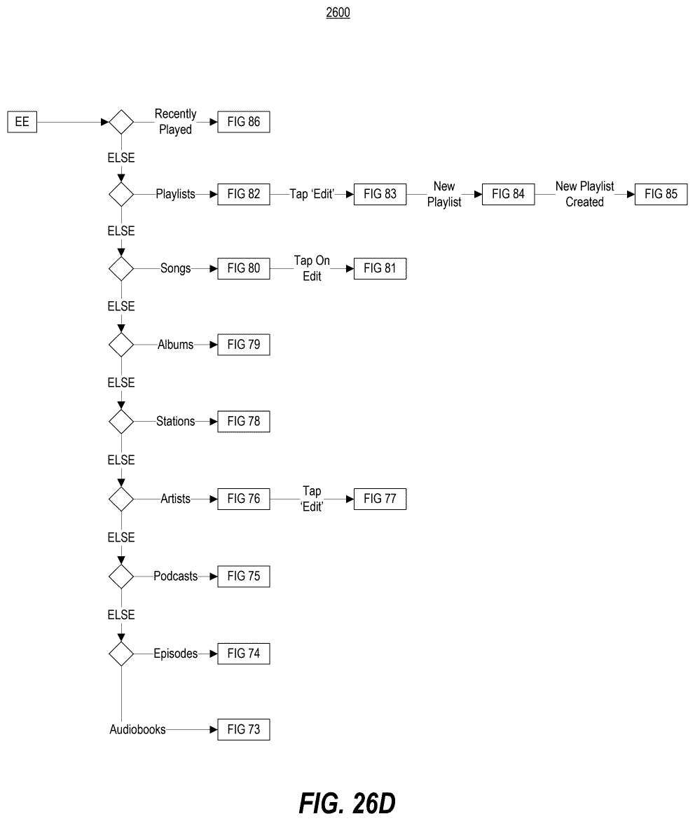

FIGS. 26A through 26D show an example operational flow diagram 2600 of a user device. One or more aspects of the operational flow diagram 2600 may be implemented to configure or present a favorite content interface (referred to as “Sonos Favorites”) and/or components thereof. The favorite content interface can provide a place where individual pieces of saved content (e.g., media items) are collected for convenience. As noted above, the media dashboard interface 802 can provide access to the favorite content interface (e.g., by selection of the view all selectable element 836 of the favorites region 830) and can provide access to a set or subset of media items saved in the favorite content interface (e.g., via the selectable elements 832 of the favorites region 830, which may show the media items most recently saved to the favorite content interface). The favorite content interface can enable users to view their entire collection of saved/accessible media content, which can be organized by the content type (e.g., playlists, albums, songs, podcasts, audiobooks, etc.).

The operational flow diagram 2600 refers to FIGS. 27A through 86, which provide example graphical user interfaces that may be presented on the user device in association with the acts or processes of the operational flow diagram 2600. FIG. 26A illustrates a “Start” block at which operations of the operational flow diagram 2600 may begin. The Start block of the operational flow diagram 2600 may correspond to running of a media application stored on the user device for configuring or controlling one or more components of a media playback system (e.g., media playback system 100) with which the user device is associated (e.g., for controlling one or more playback devices 110 of the media playback system 100). Similar to the operational flow diagram 700, the operational flow diagram 2600 includes nodes at which the user device may take various actions or cause various results depending on states present, actions taken, and/or other factors. The nodes are represented in FIGS. 26A through 26D as diamond or circular shapes. Operational flow among the blocks and nodes in operational flow diagram 2600 is indicated by arrows, which may be labeled to indicate states, actions taken, results, and/or other factors associated with the operational flow. The operational flow diagram 2600 includes linking nodes (e.g., “BB”, “CC”, “DD”, “EE”) representing links between parts of the operational flow diagram 2600 shown in different Figures. Linking nodes “BB” and “DD” represent links between parts of the operational flow diagram 2600 shown in FIGS. 26A and 26B. Linking node “CC” represents a link between parts of the operational flow diagram 2600 shown in FIGS. 26B and 26C. Linking node “EE” represents a link between parts of the operational flow diagram 2600 shown in FIGS. 26A and 26D.

### IV. Features

The disclosed technology is illustrated, for example, according to various features described below. Various examples of features of the disclosed technology are described as numbered features (1, 2, 3, etc.) for convenience. These are provided as examples and do not limit the disclosed technology. It is noted that any of the dependent features may be combined in any combination, and placed into a respective independent feature. The other features can be presented in a similar manner.

Feature 1. A device, comprising: at least one processor; and at least one non-transitory computer-readable recording medium comprising program instructions that are executable by the at least one processor such that the device is configured to: present a media dashboard interface, the media dashboard interface comprising one or more of: a recently played region, the recently played region comprising one or more selectable elements corresponding to one or more individual media items recently played by one or more playback devices of a media playback system associated with the device; a services region, the services region comprising one or more selectable elements corresponding to one or more individual media streaming services associated with a user profile; a favorites region, the favorites region comprising one or more selectable elements corresponding to one or more flagged media items associated with the user profile; or a sources region, the sources region comprising one or more selectable elements corresponding to one or more individual audio signal sources connected to one or more components of the media playback system.

Feature 2. The device of any of the preceding features, wherein the media dashboard interface further comprises: one or more pinned collection regions, each pinned collection region of the one or more pinned collection regions being associated with a respective media streaming service of the one or more individual media streaming services and comprising one or more selectable elements corresponding to one or more media items from the respective media streaming service.

Feature 3. The device of any of the preceding features, wherein the media dashboard interface further comprises: a recommended action region, the recommended action region comprising one or more selectable elements corresponding to one or more individual recommended actions for configuring or operating one or more components of the media playback system.

Feature 4. The device of any of the preceding features, wherein the media dashboard interface further comprises a search and browse selectable element, and wherein the at least one non-transitory computer-readable recording medium further comprises program instructions that are executable by the at least one processor such that the device is configured to: after selection of the search and browse selectable element, present a search and browse interface for obtaining user input indicating a search query.

Feature 5. The of any of the preceding features, wherein the media dashboard interface further comprises an edit selectable element, and wherein the at least one non-transitory computer-readable recording medium further comprises program instructions that are executable by the at least one processor such that the device is configured to: after selection of the edit selectable element, present an editing interface for adding regions, removing regions, or editing regions for the media dashboard interface.

Feature 6. The device of any of the preceding features, wherein the one or more selectable elements of the recently played region are navigable within the media dashboard interface.

Feature 7. The device of any of the preceding features, wherein each particular selectable element of the one or more selectable elements of the recently played region is associated with a respective media streaming service indicator that indicates a media streaming service for the particular selectable element.

Feature 8. The device of any of the preceding features, wherein the recently played region includes a view all selectable element, and wherein the at least one non-transitory computer-readable recording medium further comprises program instructions that are executable by the at least one processor such that the device is configured to: after selection of the view all selectable element of the recently played region, present a recently played content interface while refraining from presenting the media dashboard interface.

Feature 9. The device of any of the preceding features, wherein the recently played content interface comprises a return selectable element, and wherein the at least one non-transitory computer-readable recording medium further comprises program instructions that are executable by the at least one processor such that the device is configured to: after selection of the return selectable element of the recently played content interface, present the media dashboard interface while refraining from presenting the recently played content interface.

Feature 10. The device of any of the preceding features, wherein the one or more selectable elements of the services region are navigable within the media dashboard interface.

Feature 11. The device of any of the preceding features, wherein the services region includes a manage selectable element, and wherein the at least one non-transitory computer-readable recording medium further comprises program instructions that are executable by the at least one processor such that the device is configured to: after selection of the manage selectable element of the services region, present a service management interface while refraining from presenting the media dashboard interface.

Feature 12. The device of any of the preceding features, wherein the service management interface comprises a return selectable element, and wherein the at least one non-transitory computer-readable recording medium further comprises program instructions that are executable by the at least one processor such that the device is configured to: after selection of the return selectable element of the service management interface, present the media dashboard interface while refraining from presenting the service management interface.

Feature 13. The device of any of the preceding features, wherein the one or more selectable elements of the favorites region are navigable within the media dashboard interface.

Feature 14. The device of any of the preceding features, wherein each particular selectable element of the one or more selectable elements of the favorites region is associated with a respective media streaming service indicator that indicates a media streaming service for the particular selectable element.

Feature 15. The device of any of the preceding features, wherein the favorites region includes a view all selectable element, and wherein the at least one non-transitory computer-readable recording medium further comprises program instructions that are executable by the at least one processor such that the device is configured to: after selection of the view all selectable element of the favorites region, present a favorite content interface while refraining from presenting the media dashboard interface.

Feature 16. The device of any of the preceding features, wherein the favorite content interface comprises a return selectable element, and wherein the at least one non-transitory computer-readable recording medium further comprises program instructions that are executable by the at least one processor such that the device is configured to: after selection of the return selectable element of the favorite content interface, present the media dashboard interface while refraining from presenting the favorite content interface.

Feature 17. The device of any of the preceding features, wherein the at least one non-transitory computer-readable recording medium further comprises program instructions that are executable by the at least one processor such that the device is configured to: present a now playing bar simultaneously with the media dashboard interface.

Feature 18. A device, comprising: at least one processor; and at least one non-transitory computer-readable recording medium comprising program instructions that are executable by the at least one processor such that the device is configured to: present one or more of a media dashboard interface, a recently played content interface, a service management interface, a favorite content interface, or a search and browse interface; and present a now playing bar simultaneously with the media dashboard interface, the recently played content interface, the service management interface, the favorite content interface, or the search and browse interface, wherein the now playing bar comprises: a media information region; a play/pause element; and a progress tracking element that provides a visual representation of playback progress of a media item currently being played by one or more playback devices of a media playback system associated with the device, wherein the visual representation comprises visual changing of a perimeter or an area of the play/pause element, and wherein the visual changing of the perimeter or the area of the play/pause element indicates the playback progress of the media item currently being played.

Feature 19. The device of any of the preceding features, wherein the now playing bar further comprises: a volume control element; and a grouping control element.

Feature 20. The device of any of the preceding features, wherein the at least one non-transitory computer-readable recording medium further comprises program instructions that are executable by the at least one processor such that the device is configured to: receive user input directed to the now playing bar; and after receiving the user input directed to the now playing bar, present a now playing interface, wherein the now playing interface comprises an alternative progress tracking element that provides an alternative visual representation of the playback progress of the media item currently being played, wherein the alternative visual representation comprises visual changing of a linear space that is offset from an alternative play/pause element of the now playing interface.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

What is currently claimed is:

1. A device, comprising:
at least one processor; and
at least one non-transitory computer-readable recording medium comprising program instructions that are executable by the at least one processor such that the device is configured to:
present a media dashboard interface, the media dashboard interface comprising one or more of:
a recently played region, the recently played region comprising one or more selectable elements corresponding to one or more individual media items recently played by one or more playback devices of a media playback system associated with the device;
a services region, the services region comprising one or more selectable elements corresponding to one or more individual media streaming services associated with a user profile;
a favorites region, the favorites region comprising one or more selectable elements corresponding to one or more flagged media items associated with the user profile; or
a sources region, the sources region comprising one or more selectable elements corresponding to one or more individual audio signal sources connected to one or more components of the media playback system.

2. The device of claim 1, wherein the media dashboard interface further comprises:
one or more pinned collection regions, each pinned collection region of the one or more pinned collection regions being associated with a respective media streaming service of the one or more individual media streaming services and comprising one or more selectable elements corresponding to one or more media items from the respective media streaming service.

3. The device of claim 1, wherein the media dashboard interface further comprises:
a recommended action region, the recommended action region comprising one or more selectable elements corresponding to one or more individual recommended actions for configuring or operating one or more components of the media playback system.

4. The device of claim 1, wherein the media dashboard interface further comprises a search and browse selectable element, and wherein the at least one non-transitory computer-readable recording medium further comprises program instructions that are executable by the at least one processor such that the device is configured to:
after selection of the search and browse selectable element, present a search and browse interface for obtaining user input indicating a search query.

5. The device of claim 1, wherein the media dashboard interface further comprises an edit selectable element, and wherein the at least one non-transitory computer-readable recording medium further comprises program instructions that are executable by the at least one processor such that the device is configured to:
after selection of the edit selectable element, present an editing interface for adding regions, removing regions, or editing regions for the media dashboard interface.

6. The device of claim 1, wherein the one or more selectable elements of the recently played region are navigable within the media dashboard interface.

7. The device of claim 1, wherein each particular selectable element of the one or more selectable elements of the recently played region is associated with a respective media streaming service indicator that indicates a media streaming service for the particular selectable element.

8. The device of claim 1, wherein the recently played region includes a view all selectable element, and wherein the at least one non-transitory computer-readable recording medium further comprises program instructions that are executable by the at least one processor such that the device is configured to:
after selection of the view all selectable element of the recently played region, present a recently played content interface while refraining from presenting the media dashboard interface.

9. The device of claim 8, wherein the recently played content interface comprises a return selectable element, and wherein the at least one non-transitory computer-readable recording medium further comprises program instructions that are executable by the at least one processor such that the device is configured to:
after selection of the return selectable element of the recently played content interface, present the media dashboard interface while refraining from presenting the recently played content interface.

10. The device of claim 1, wherein the one or more selectable elements of the services region are navigable within the media dashboard interface.

11. The device of claim 1, wherein the services region includes a manage selectable element, and wherein the at least one non-transitory computer-readable recording medium further comprises program instructions that are executable by the at least one processor such that the device is configured to:
after selection of the manage selectable element of the services region, present a service management interface while refraining from presenting the media dashboard interface.

12. The device of claim 11, wherein the service management interface comprises a return selectable element, and wherein the at least one non-transitory computer-readable recording medium further comprises program instructions that are executable by the at least one processor such that the device is configured to:
after selection of the return selectable element of the service management interface, present the media dashboard interface while refraining from presenting the service management interface.

13. The device of claim 1, wherein the one or more selectable elements of the favorites region are navigable within the media dashboard interface.

14. The device of claim 1, wherein each particular selectable element of the one or more selectable elements of the favorites region is associated with a respective media streaming service indicator that indicates a media streaming service for the particular selectable element.

15. The device of claim 1, wherein the favorites region includes a view all selectable element, and wherein the at least one non-transitory computer-readable recording medium further comprises program instructions that are executable by the at least one processor such that the device is configured to:
after selection of the view all selectable element of the favorites region, present a favorite content interface while refraining from presenting the media dashboard interface.

16. The device of claim 15, wherein the favorite content interface comprises a return selectable element, and wherein the at least one non-transitory computer-readable recording medium further comprises program instructions that are executable by the at least one processor such that the device is configured to:
after selection of the return selectable element of the favorite content interface, present the media dashboard interface while refraining from presenting the favorite content interface.

17. The device of claim 1, wherein the at least one non-transitory computer-readable recording medium further comprises program instructions that are executable by the at least one processor such that the device is configured to:
present a now playing bar simultaneously with the media dashboard interface.

18. A device, comprising:
at least one processor; and
at least one non-transitory computer-readable recording medium comprising program instructions that are executable by the at least one processor such that the device is configured to:
present one or more of a media dashboard interface, a recently played content interface, a service management interface, a favorite content interface, or a search and browse interface; and
present a now playing bar simultaneously with the media dashboard interface, the recently played content interface, the service management interface, the favorite content interface, or the search and browse interface, wherein the now playing bar comprises:
a media information region;
a play/pause element; and
a progress tracking element that provides a visual representation of playback progress of a media item currently being played by one or more playback devices of a media playback system associated with the device, wherein the visual representation comprises visual changing of a perimeter or an area of the play/pause element, and wherein the visual changing of the perimeter or the area of the play/pause element indicates the playback progress of the media item currently being played.

19. The device of claim 18, wherein the now playing bar further comprises:
a volume control element; and
a grouping control element.

20. The device of claim 18, wherein the at least one non-transitory computer-readable recording medium further comprises program instructions that are executable by the at least one processor such that the device is configured to:
receive user input directed to the now playing bar; and
after receiving the user input directed to the now playing bar, present a now playing interface, wherein the now playing interface comprises an alternative progress tracking element that provides an alternative visual representation of the playback progress of the media item currently being played, wherein the alternative visual representation comprises visual changing of a linear space that is offset from an alternative play/pause element of the now playing interface.
